(19) United States
(12) Patent Application Publication
(10) Pub. No.: US 2025/0086331 A1
(43) Pub. Date: Mar. 13, 2025

(54) COMPUTER-ASSISTED INTERACTIONS FOR PHOTOVOLTAIC WIRING SYSTEM DESIGN AND INSTALLATION

(71) Applicant: Ningbo Xiaofu Technology Co., Ltd., Ningbo (CN)

(72) Inventors: Li WANG, Ningbo (CN); Ruiyan GE, Ningbo (CN); Shihan HONG, Ningbo (CN); Shilong LIU, Ningbo (CN); Wanru SHI, Ningbo (CN); Changan ZOU, Ningbo (CN); Xinbo YAN, Ningbo (CN); Zhengyu HAN, Ningbo (CN); Yeru LI, Ningbo (CN); Haoran SONG, Ningbo (CN)

(21) Appl. No.: 18/730,288

(22) PCT Filed: Sep. 11, 2023
(86) PCT No.: PCT/CN2023/117961

§ 371 Date: Jul. 18, 2024

(51) Int. Cl. G06F 30/12; G06F 113/16; G06T 19/20

(52) U.S. Cl. CPC G06F 30/12; G06T 19/20; G06F 2113/16; G06T 2219/2004; G06T 2219/2008

(57) ABSTRACT

An example method for generating a three-dimensional (3D) illustration of a photovoltaic panel array current distribution wiring system for photovoltaic panel array current distribution wiring system installation, comprising obtaining initial photovoltaic panel array current distribution wiring system installation parameters, determining the 3D illustration of the photovoltaic panel array current distribution wiring system based on the initial photovoltaic panel array current distribution wiring system installation parameters and information of a site environment of the photovoltaic panel array current distribution wiring system, and determining actual photovoltaic panel array current distribution wiring system installation parameters using the 3D illustration of the photovoltaic panel array current distribution wiring system.

### BACKGROUND OF THE INVENTION

The present disclosure relates generally to the field of photovoltaic panel array current distribution wiring system, and more specifically to computer-assisted interactions for photovoltaic wiring system design and installation.

### SUMMARY OF THE INVENTION

An example method for generating a three-dimensional (3D) illustration of a photovoltaic panel array current distribution wiring system for photovoltaic panel array current distribution wiring system installation, comprising obtaining initial photovoltaic panel array current distribution wiring system installation parameters, determining the 3D illustration of the photovoltaic panel array current distribution wiring system based on the initial photovoltaic panel array current distribution wiring system installation parameters and information of a site environment of the photovoltaic panel array current distribution wiring system, and determining actual photovoltaic panel array current distribution wiring system installation parameters using the 3D illustration of the photovoltaic panel array current distribution wiring system.

An example method for assisting photovoltaic panel array current distribution wiring system installation using a three-dimensional (3D) illustration of the photovoltaic panel array current distribution wiring system comprises obtaining the 3D illustration of the photovoltaic panel array current distribution wiring system determined based on photovoltaic panel array current distribution wiring system installation parameters, illustrating the 3D illustration of the photovoltaic panel array current distribution wiring system to a virtual observer based on a field of view (FOV) of the virtual observer, receiving inputs corresponding to photovoltaic panel array current distribution wiring system installation operations from the virtual observer, and providing feedback responsive to the inputs.

An example method for three-dimensional (3D) illustration of a real-world photovoltaic cable manufacturing facility, comprises obtaining the 3D illustration of the real-world photovoltaic cable manufacturing facility, illustrating the 3D illustration to a virtual observer based on a field of view (FOV) of the virtual observer, wherein the 3D illustration illustrates equipment and processes for manufacturing photovoltaic cables, receiving the virtual observer inputs corresponding to an inquiry of information of equipment or processes of the real-world photovoltaic cable manufacturing facility, and providing the inquired information to the virtual observer.

An example method for assisting photovoltaic panel array current distribution wiring system installation using a three-dimensional (3D) illustration of the photovoltaic panel array current distribution wiring system, comprises obtaining the 3D illustration of the photovoltaic panel array current distribution wiring system determined based on photovoltaic panel array current distribution wiring system installation parameters, illustrating the 3D illustration of the photovoltaic panel array current distribution wiring system to a plurality of virtual observers individually based on a field of view (FOV) of each virtual observer of the plurality of virtual observers, receiving inputs corresponding to photovoltaic panel array current distribution wiring system installation operations from the plurality of virtual observers, and updating the 3D illustration of the photovoltaic panel array current distribution wiring system based on the inputs from the plurality of virtual observers.

An example method for three-dimensional (3D) illustration of a photovoltaic panel array current distribution wiring system, comprises obtaining the 3D illustration of the photovoltaic panel array current distribution wiring system determined based on photovoltaic panel array current distribution wiring system installation parameters, illustrating the 3D illustration of the photovoltaic panel array current distribution wiring system to a virtual observer based on a field of view (FOV) of the virtual observer, receiving inputs corresponding to inquiry of information of equipment or processes of the photovoltaic panel array current distribution wiring system, and providing feedback responsive to the user input.

An example computer-readable medium storing instructions for generating a three-dimensional (3D) illustration of a photovoltaic panel array current distribution wiring system for photovoltaic panel array current distribution wiring system installation, the instructions comprising code for obtaining initial photovoltaic panel array current distribution wiring system installation parameters, determining the 3D illustration of the photovoltaic panel array current distribution wiring system based on the initial photovoltaic panel array current distribution wiring system installation parameters and information of a site environment of the photovoltaic panel array current distribution wiring system, and determining actual photovoltaic panel array current distribution wiring system installation parameters using the 3D illustration of the photovoltaic panel array current distribution wiring system.

An example computer-readable medium storing instructions for assisting photovoltaic panel array current distribution wiring system installation using a three-dimensional (3D) illustration of the photovoltaic panel array current distribution wiring system, the instructions comprising code for obtaining the 3D illustration of the photovoltaic panel array current distribution wiring system determined based on photovoltaic panel array current distribution wiring system installation parameters, illustrating the 3D illustration of the photovoltaic panel array current distribution wiring system to a virtual observer based on a field of view (FOV) of the virtual observer, receiving inputs corresponding to photovoltaic panel array current distribution wiring system installation operations from the virtual observer, and providing feedback responsive to the inputs.

An example computer-readable medium storing instructions for three-dimensional (3D) illustration of a real-world photovoltaic cable manufacturing facility, the instructions comprising code for obtaining the 3D illustration of the real-world photovoltaic cable manufacturing facility, illustrating the 3D illustration to a virtual observer based on a field of view (FOV) of the virtual observer, wherein the 3D illustration illustrates equipment and processes for manufacturing photovoltaic cables, receiving the virtual observer inputs corresponding to inquiry of information of equipment or processes of the real-world photovoltaic cable manufacturing facility, and providing the inquired information to the virtual observer.

An example computer-readable medium storing instructions for assisting photovoltaic panel array current distribution wiring system installation using a three-dimensional (3D) illustration of the photovoltaic panel array current distribution wiring system, the instructions comprising code for obtaining the 3D illustration of the photovoltaic panel array current distribution wiring system determined based on photovoltaic panel array current distribution wiring system installation parameters, illustrating the 3D illustration of the photovoltaic panel array current distribution wiring system to a plurality of virtual observers individually based on a field of view (FOV) of each virtual observer of the plurality of virtual observers, receiving inputs corresponding to photovoltaic panel array current distribution wiring system installation operations from the plurality of virtual observers, and updating the 3D illustration of the photovoltaic panel array current distribution wiring system based on the inputs from the plurality of virtual observers.

An example computer-readable medium storing instructions for three-dimensional (3D) illustration of a photovoltaic panel array current distribution wiring system, the instructions comprising code for obtaining the 3D illustration of the photovoltaic panel array current distribution wiring system determined based on photovoltaic panel array current distribution wiring system installation parameters, illustrating the 3D illustration of the photovoltaic panel array current distribution wiring system to a virtual observer based on a field of view (FOV) of the virtual observer, receiving inputs corresponding to inquiry of information of equipment or processes of the photovoltaic panel array current distribution wiring system, and providing feedback responsive to the user input.

This summary is neither intended to identify key or essential features of the claimed subject matter nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1A is a block diagram of generating a three-dimensional (3D) illustration of a photovoltaic panel array current distribution wiring system for photovoltaic panel array current distribution wiring system installation, according to some embodiments.

FIG. 1B is a block diagram of UIs corresponding to each block shown in FIG. 1A, according to some embodiments.

FIG. 1C is a flow diagram of generating a three-dimensional (3D) illustration of a photovoltaic panel array current distribution wiring system for photovoltaic panel array current distribution wiring system installation, according to some embodiments.

FIGS. 2A-2B are block diagrams of assisting photovoltaic panel array current distribution wiring system installation using a 3D illustration of the photovoltaic panel array current distribution wiring system, according to some embodiments.

FIG. 2C is a perspective view of an example of a near-eye display in the form of an HMD device for implementing some of the examples disclosed herein.

FIG. 2D is a flow diagram of assisting photovoltaic panel array current distribution wiring system installation using a 3D illustration of the photovoltaic panel array current distribution wiring system, according to some embodiments.

FIGS. 2E-2G show examples UIs for photovoltaic panel array current distribution wiring system installation training, according to some embodiments.

FIGS. 2H-2Z show further examples UIs for photovoltaic panel array current distribution wiring system installation training, according to some embodiments.

FIG. 3A is a block diagram of 3D illustration of a real-world photovoltaic cable manufacturing facility, according to some embodiments.

FIG. 3B is a flow diagram of 3D illustration of a real-world photovoltaic cable manufacturing facility, according to some embodiments.

FIGS. 3C and 3D show examples of 3D illustration of the real-world photovoltaic cable manufacturing facility, according to some embodiments.

FIG. 4A is a block diagram of assisting photovoltaic panel array current distribution wiring system installation using a 3D illustration of the photovoltaic panel array current distribution wiring system, according to some embodiments.

FIGS. 4B-4D show examples UI with brush and eraser according to some embodiments.

FIG. 4E is a simplified illustration of a multiple commuting device communication system in which s HMD, s server, and/or other components of the communication system can use the techniques provided herein for simultaneously interacting in the 3D illustration of a photovoltaic panel array current distribution wiring system.

FIG. 4F is a flow diagram of assisting photovoltaic panel array current distribution wiring system installation using a 3D illustration of the photovoltaic panel array current distribution wiring system, according to some embodiments.

FIGS. 4G-4K show further examples UIs of assisting photovoltaic panel array current distribution wiring system installation using a 3D illustration of the photovoltaic panel array current distribution wiring system, according to some embodiments.

FIG. 5A is a block diagram of 3D illustration of a photovoltaic panel array current distribution wiring system, according to some embodiments.

FIG. 5B is a flow diagram of 3D illustration of a photovoltaic panel array current distribution wiring system, according to some embodiments.

FIGS. 6A and 6B illustrate example UIs of the 3D illustration, according to some embodiments.

FIG. 7 is a block diagram of an embodiment of a computer system, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The advantages of using 3D illustration (e.g., may also be referred to as 3D modeling) for photovoltaic panel array current distribution wiring system installation over 2D blueprints/drawings are significant. Primarily, 3D modeling provides a more accurate representation of real-world scenarios. This is especially crucial when simulating unique geographical environments where cables need to be positioned realistically. With 3D modeling, cable lengths can be determined with greater precision. Furthermore, it allows for specifying bend radii for particular cables, preventing potential damage due to excessive bending. Such detailed modeling/illustration not only reduces the learning curve for installers (e.g., construction workers) but also diminishes the likelihood of installation errors. Additionally, 3D models serve as effective promotional tools for the product, showcasing its features and capabilities in a more immersive manner.

The photovoltaic panel array current distribution wiring system installation described hereinafter may include the design and the installation of the solar farm.

Solution A: Generating a three-dimensional (3D) illustration of a photovoltaic panel array current distribution wiring system (also referred as solar power, solar power station, photovoltaic power, photovoltaic power station hereinafter) for photovoltaic panel array current distribution wiring system installation.

The technical solution disclosed herein may be used for application in the photovoltaic sector, particularly in photovoltaic panel array current distribution wiring systems/solar farms/powers. This solution leverages 3D modeling techniques to precisely emulate the real-world conditions of the site. A notable feature of this approach is its ability to accurately calculate cable lengths required on-site and ensure they meet the established standards. This precision not only optimizes the material usage but also ensures the reliability and efficiency of the solar power installations.

In some embodiments, upon receiving a client order, the workflow for the application of this product begins as follows: (1) Client Order Receipt and Initial Planning: Once a client's order is received, a wiring harness plan is formulated based on the client's specifications. (2) Component Modeling: Using the component data from the client-provided bracket diagram, necessary component models are created. This includes the specifications for photovoltaic modules, dimensions of the bracket motors, types and models of injection-molded parts, clamp sizes, and types of hooks, among others. (3) Positioning and Layout: Leveraging the pile position data from the bracket diagram provided by the client, the created component models can be accurately positioned. Key data points considered include spacings like those between photovoltaic modules, brackets, junction boxes, and positions of various injection-molded components. (4) Structural Assembly: With reference to the detailed component diagrams provided, all bracket motors are interconnected using torque tubes. Adjustments are made to the rotation angle of the photovoltaic modules and the overall height of the bracket system. (5) Component Connection: Based on the custom wiring harness plan, adjacent photovoltaic modules are interconnected. These connections may vary, including series, bypass, or reverse connections, depending on the client's needs. (6) Cable Routing: Cable layouts are executed as per the client-specified wiring harness plan. The mode of cable routing, be it quantitative or non-quantitative, is tailored to the client's specifications. (7) Cable Bundling: Using the electrical data from the client diagrams, cable harnesses are bundled using ties, keeping in mind specific requirements such as not bundling ties on injection-molded parts and ensuring ties are snug against the cables. (8) Model Export and Texture Mapping: The model is exported to 3D modeling software, where textures are applied. These textures, designed to mirror real-world counterparts, enhance the model's visual authenticity. (9) Camera Simulation: Once texturing is complete, the entire model is photographed, simulating different camera angles, capturing various perspectives like aerial views and close-ups of cable injection-molded parts. (10) Post-Processing: After photography, rendering post-processing filters (e.g., lighting, reflectivity, parallax) are adjusted to ensure the animations and images meet desired outcomes. (11) Annotation in photo/video processing/generating software: The final renderings are imported into image processing/generating software, where specific client-requested annotations are added. Once annotated, these images are seamlessly integrated into specialized 3D page templates. (12) Client Delivery: Finally, the client is presented with customized 3D rendered videos, specialized 3D page images, and precise quantitative data analysis, ensuring they have a comprehensive understanding and visualization of their order. The workflow disclosed herein encapsulates a rigorous process that prioritizes client requirements at every stage, ensuring the delivery of high-quality 3D models that meet and often exceed expectations.

Specifically, in some embodiments, the client may provide a bracket/mounting diagram, electrical/wire diagram and partial CAB Information. The technical solution disclosed herein may include two main segments: Model Creation and Material Design.

Model Creation: Tailored to the distinct needs of various clients, our system produces different bracket systems, including but not limited to ATI, GameChange, NextTracker, etc. The data for these models are meticulously crafted in a one-to-one ratio, harmonizing the blueprints (e.g., 2D drawings) provided by clients with on-site schematics. The detail and finesse embedded in these models resonate with the tangible entities present on the site. Owing to the plethora of models developed, the technical solution disclosed herein institutes a comprehensive model asset library. This repository boasts an array of bracket components encountered to date. To facilitate efficiency, models can be directly extracted from this library as per client specifications during the simulation of cable assembly. Furthermore, this asset library is in a state of continual refinement, enabling real-time modifications and augmentations based on evolving client needs.

Material Design: In a pursuit to achieve authentic and visually striking render outcomes, our product harnesses the PBR (Physically-Based Rendering) material methodology. This material encapsulates the essence of micro-surfaces, the BRDF (Bidirectional Reflectance Distribution Function), and conserves energy to meticulously reproduce the attributes of real-world objects in 3D renderings. In practical application, PBR delineates materials via foundational color, metallicity, and roughness. Using aluminum as an example, its foundational hue resonates with sRGB values of 245, 246, and 246, and its metallicity peaks at 100%. It is noteworthy that the metallicity spectrum spans from 0 to 1, and non-metallic substances typically oscillate between 2-5% metallicity. The roughness, however, is contingent upon the extant environmental parameters. For instance, polished aluminum manifests a roughness of about 20%, whereas oxidized or worn aluminum can exhibit roughness levels between 40-60%. In stark contrast, completely rough rubber can register roughness values between 90-100%. By finetuning these attributes, our product delivers materials that vividly echo real-world physical effects. When paired with the renderer's lighting nuances, this culminates in photorealistic rendering outcomes.

In some embodiments, a plugin (e.g., The SolarStationSimulationtools), hereinafter referred to as the “Plugin,” may be designed to serve as an enhancement module specifically crafted for the design software. By incorporating this Plugin, users can leverage an expanded set of capabilities within the design software, thereby achieving heightened work efficiency. The Plugin has been meticulously designed to cater to distinct project requirements and application scenarios that users may encounter. The Plugin is presented in the form of multiple “.py” files and is conveniently encapsulated within a zip file for optimal compatibility and ease of use.

Upon integrating into the design software, users can swiftly navigate to the software's plugin directory, locate the Plugin, and activate it by selecting the associated checkbox. A distinguishing aspect of this Plugin is its tripartite functional layout. Firstly, it offers a ‘Curve Property Configuration’ which facilitates the renaming of curves, the stipulation of curve attributes such as diameter, material, and color, and the overall definition of the curve's characteristics. Once a specific curve is selected and assigned a name, the Plugin showcases its nomenclature by amalgamating the new name, the curve's length, and its designated material type. Secondly, the ‘Curve Length and Curvature Computation’ functionality is dedicated to determining the precise length of the drawn curve within a project design. Additionally, it assesses the curve's specific bend radius. In scenarios where a curve's bending radius falls below a predetermined default, the Plugin flags this discrepancy with a distinctive red marker. Conversely, curves that adhere to the established parameters are marked in green, allowing users to discern and make necessary adjustments. Lastly, the Plugin boasts a ‘Curve Data Export’ feature. This functionality is geared towards exporting selected curve data. Notably, it offers bifurcated data tables. One is a streamlined external table tailored for client viewing, predominantly highlighting the curve name and length. In contrast, the internal table, meant for designers, provides an in-depth view, displaying additional data points like line number, material, diameter, bend radius, and a qualifier indicating the acceptability of the bend radius. In terms of its technical underpinnings, the Plugin is grounded in programming languages. Development and coding were executed using a code compiler, with design software being the platform for subsequent testing and utilization.

Accordingly, the technology disclosed herein renders based on the actual data and effects of photovoltaic modules, accurately achieving realistic and aesthetically pleasing 3D simulations of the photovoltaic modules. This could reduce the learning costs for construction workers and is applicable to real engineering projects.

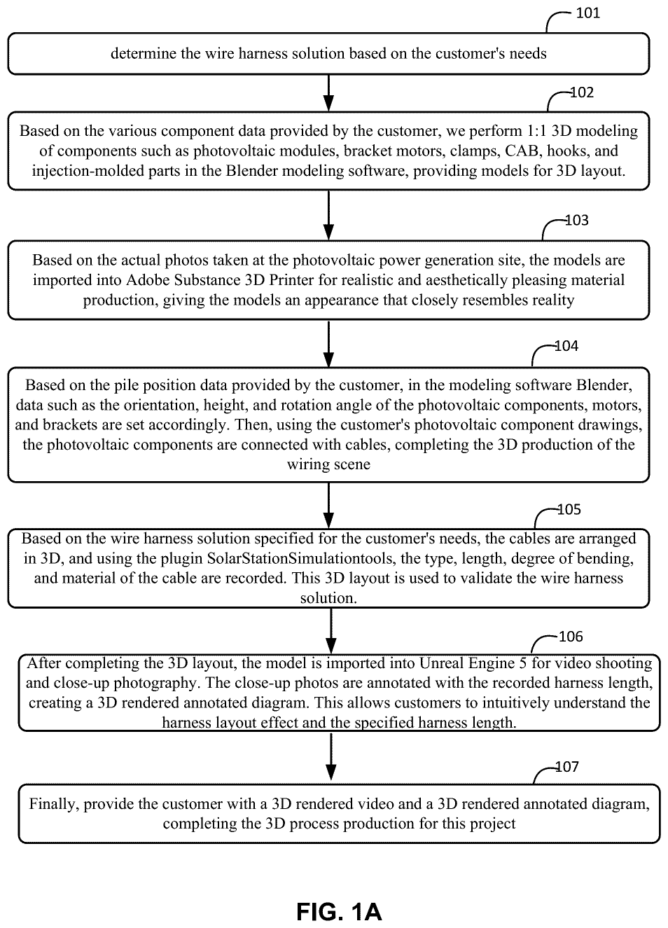

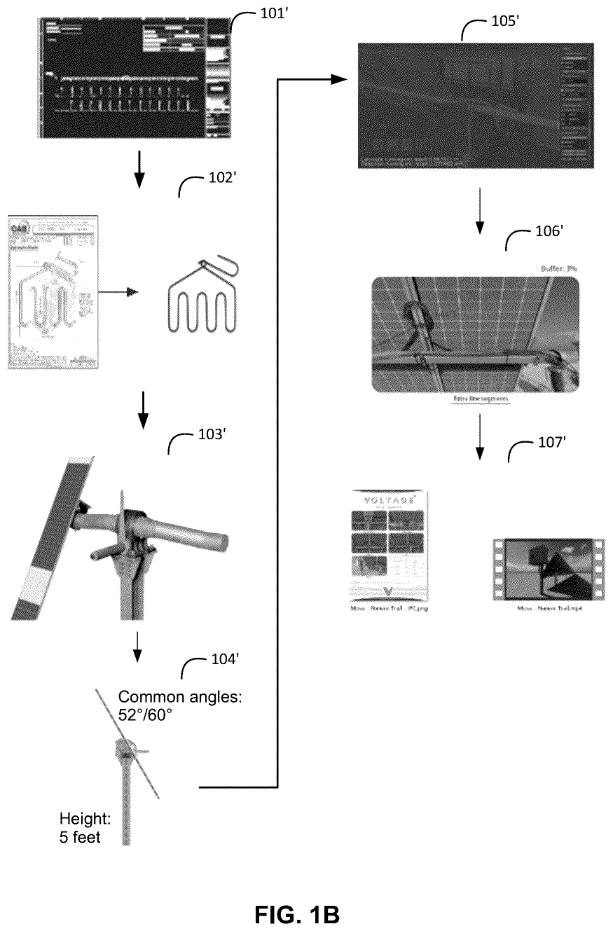

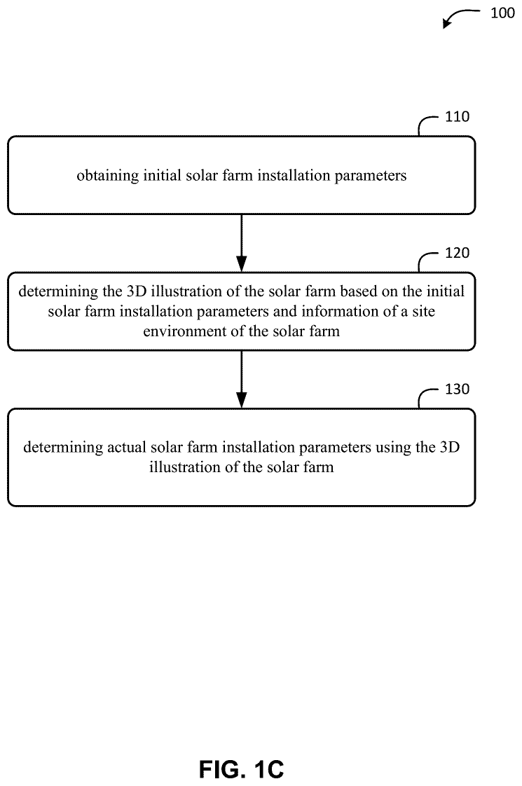

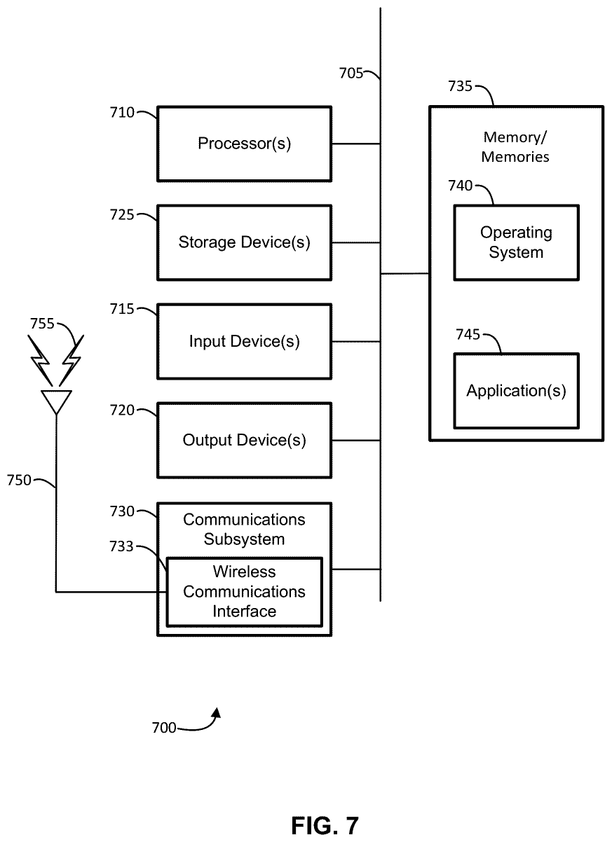

FIG. 1A is a block diagram for generating a three-dimensional (3D) illustration of a solar farm for solar farm installation, according to some embodiments. The structure for performing the functionality illustrated in one or more of the blocks shown in FIG. 1A may be performed by hardware and/or software components of a computerized apparatus or system. Components of such computerized apparatus or system may include, for example, one or more processors, one or more controllers, a computerized system, or a computer-readable apparatus including a storage medium storing computer-readable and/or computer-executable instructions that are configured to, when executed by one or more processors, cause the one or more processors or a computerized apparatus to perform the operations. Example components of a computer system are illustrated in FIG. 7, which are described in more detail below.

At block 101, the wire harness solution is determine based on the customer's needs.

At block 102, based on the various component data provided by the customer, we perform 1:1 3D modeling of components such as photovoltaic modules, bracket motors, clamps, CAB, hooks, and injection-molded parts in the Blender modeling software, providing models for 3D layout.

At block 103, based on the actual photos taken at the photovoltaic power generation site, the models are imported into Adobe Substance 3D Printer for realistic and aesthetically pleasing material production, giving the models an appearance that closely resembles reality.

At block 104, based on the pile position data provided by the customer, in the modeling software Blender, data such as the orientation, height, and rotation angle of the photovoltaic components, motors, and brackets are set accordingly. Then, using the customer's photovoltaic component drawings, the photovoltaic components are connected with cables, completing the 3D production of the wiring scene.

At block 105, based on the wire harness solution specified for the customer's needs, the cables are arranged in 3D, and using the plugin SolarStationSimulationtools, the type, length, degree of bending, and material of the cable are recorded. This 3D layout is used to validate the wire harness solution.

At block 106, after completing the 3D layout, the model is imported into Unreal Engine 5 for video shooting and close-up photography. The close-up photos are annotated with the recorded harness length, creating a 3D rendered annotated diagram. This allows customers to intuitively understand the harness layout effect and the specified harness length.

At block 107, finally, provide the customer with a 3D rendered video and a 3D rendered annotated diagram, completing the 3D process production for this project.

FIG. 1B is a block diagram of UIs corresponding to each block shown in FIG. 1A, according to some embodiments. For example, UI 101′ will correspond to block 101 (e.g., when block 101 is performed, UI 101′ may show). UIs 102′, 103′ . . . and 107′ in FIG. 1B correspond to blocks 102, 103, . . . and 107 respectively.

FIG. 1C is a flow diagram of a method 100 for generating a three-dimensional (3D) illustration of a solar farm for solar farm installation, according to some embodiments. The structure for performing the functionality illustrated in one or more of the blocks shown in FIG. 1C may be performed by hardware and/or software components of a computerized apparatus or system. Components of such computerized apparatus or system may include, for example, one or more processors, one or more controllers, a computerized system, or a computer-readable apparatus including a storage medium storing computer-readable and/or computer-executable instructions that are configured to, when executed by one or more processors, cause the one or more processors or a computerized apparatus to perform the operations. Example components of a computer system are illustrated in FIG. 7, which are described in more detail below.

At block 110, the functionality may include obtaining initial solar farm installation parameters.

At step 120, the functionality may include determining the 3D illustration of the solar farm based on the initial solar farm installation parameters and information of a site environment of the solar farm.

At step 120, the functionality may include determining actual solar farm installation parameters using the 3D illustration of the solar farm.

In some embodiments, the initial solar farm installation parameters comprise data from a bracket diagram, a wiring diagram, or both, determined for the solar farm installation.

In some embodiments, the data from the bracket diagram comprises specifications for photovoltaic modules; dimensions of bracket motors; types and models of injection-molded parts; dimensions of clamps; types of hooks; pile position data; or any combination thereof.

In some embodiments, determining the 3D model illustration of the solar farm further comprises modeling components of the solar farm, wherein the components comprise photovoltaic modules; positioning at least one of the modeled components; and connecting the photovoltaic modules.

In some embodiments, connecting the photovoltaic modules comprises series connections; jump connections; polarity connections; or any combination thereof.

In some embodiments, determining the 3D model illustration of the solar farm further comprises routing cables connecting at least some of the modeled components; and binding the cables according to on-site requirements.

In some embodiments, determining the 3D model illustration of the solar farm further comprises performing material mapping based on extracting textures through comparisons with images of actual site; performing model photography by simulating from various camera angles; and performing post-rendering adjustments.

In some embodiments, determining the actual solar farm installation parameters further comprises determining an actual total cable length for the solar farm installation.

In some embodiments, the 3D illustration of the solar farm comprises a 3D exclusive rendered video, a 3D exclusive page diagram, or both, wherein the 3D illustration of the solar farm indicates the actual solar farm installation parameters.

Solution B: Assisting solar farm installation using a 3D illustration of the solar farm. The technical solution disclosed herein enables the installers of the solar farm to be trained on the installation process of the solar farm using a 3D illustration of the solar farm before the commencement of on-site work (e.g., work in the real world). This training provides installers with an intuitive and clear understanding of the entire installation process without needing prior physical contact with the actual materials. As a result, the efficiency during the actual construction is enhanced, and the probability of errors is reduced.

In some embodiments, based on the customer's photovoltaic power station design diagram, the modeling team first establishes the three-dimensional layout (also referred as 3D illustration, 3D modeling) of the photovoltaic power station and creates the artistic assets, including models and textures. Then, firstly, the power station layout and artistic assets are imported into a 2D/3D real-time development platform. Scene processing and optimization tools are then utilized to craft scenes that are filled with artistic assets and optimized for performance. Subsequently, based on the actual conditions of the photovoltaic power station, interactive step-by-step procedures are formulated and implemented. Additionally, the necessary user interface (UI) is created using the UI development framework.

In some embodiments, as a non-limiting example, when using, the user/virtual observer will enter a completely dark environment, followed by the company's LOGO and a start button emerging. Upon clicking the start button, the user/virtual observer will be transported to the installation simulation scene, with installation process steps and UI operation prompts displayed in front of the user/virtual observer. The subsequent process will vary depending on the specific project, such as: Photovoltaic module installation: the user/virtual observer needs to install the photovoltaic modules in the corresponding positions on the brackets. During installation, the installation operation is judged. If the installation position and angle roughly match, it is considered a successful installation. The photovoltaic module will automatically adjust its position and angle to an ideal state, accompanied by success effects and sound effects. However, if the installation posture deviates significantly, the VR handle and vibration wristband will emit strong vibrations to notify users of the installation error, requiring readjustment. All installation operations will have the aforementioned judgment rules and user feedback. After one photovoltaic module is successfully installed, the remaining modules in the field will automatically complete installation sequentially. Choose the required installation tools (e.g., wire spool and/or wire box). During installation simulation, only one area is usually designated as the installation target. The user/virtual observer need to judge based on the spool label, box label, and information on the power station design diagram. The user/virtual observer then select the required wire spool and wire box by clicking the buttons above the user/virtual observer. If chosen correctly, the spool and wire box will move onto the transport vehicle, accompanied by success effects and sound effects. But if chosen wrongly, a text prompt will pop up near the button, and the VR handle and vibration wristband will also emit strong vibrations. All selection operations will have the aforementioned judgment rules and user feedback. Choose the combiner box for the target installation area. The user (e.g., the virtual observer) walk around the scene (e.g., changing the field of view (FOV)), combining the power station design diagram and their observations (e.g., determined based on the FOV) to select the combiner box of the target installation area by clicking on its button. If selected correctly, the transport vehicle loaded with the wire spool and wire box will move close to the combiner box. Choose the starting position and direction for wire spool unwinding. The user/virtual observer will make choices based on the spool label and information on the power station design diagram. If selected correctly, an animation of the wire spool unwinding, and main cable installation will play. Complete several connections between photovoltaic modules, main cables, and between photovoltaic modules according to the prompts. Remove the Whip wire bundle from the wire box and filter out the required installation based on the label above. Move the necessary Whip wire bundle to the specified area; the bundle will be automatically untied. Connect both ends of the Whip wire to the main cable and the combiner box's outgoing wire, respectively. Sometimes, the combiner box and the main cable are not on the same bracket row, so the Whip wire needs to connect both ends through a conduit. Insert one end of the Whip wire into the conduit, and it will subsequently emerge from the other end of the conduit.

In some embodiments, the installation practice may involve connecting connectors. For example, the connectors can be between aluminum (Al) wire to Al wire, Al wire to copper (Cu) wire, and/or Cu wire to Cu wires. The connectors may be trunk buses connecting trunk wires with brunch wires.

Through virtual reality (VR), there's no need for physical objects or to be in a real location, which greatly facilitating the training process. Unlike the traditional combination of keyboard plus mouse and 2D screens, after wearing VR, the users/virtual observers can move their heads and hands with high precision and freedom. This allows the users/virtual observers to install photovoltaic modules and connect cables both intuitively and easily. After the users/virtual observers perform operations, VR immediately provides multi-dimensional feedback, including visual, auditory, and tactile sensations. The entire process feels very realistic, leaving a profound impression on users and thus enhancing the training effect.

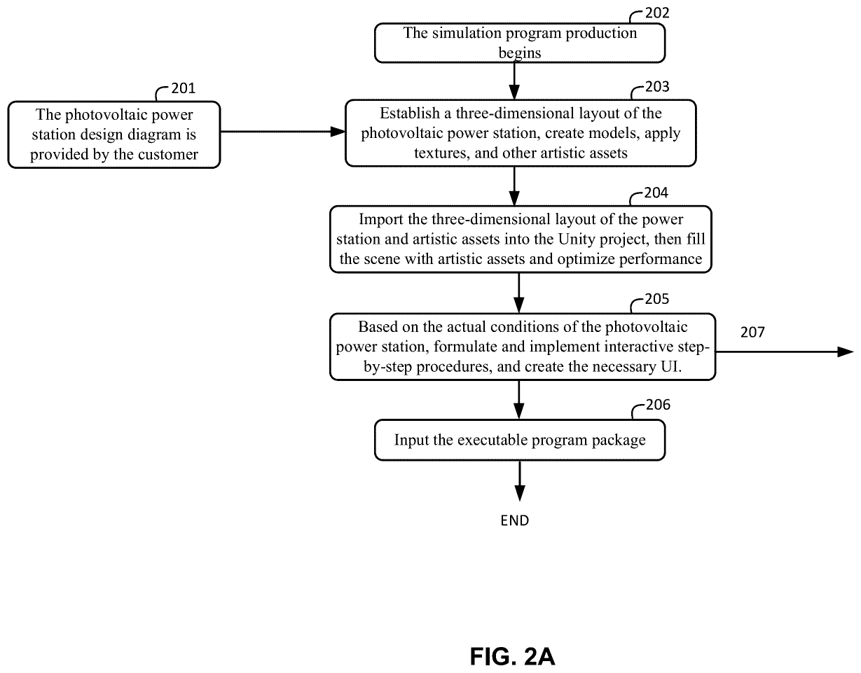

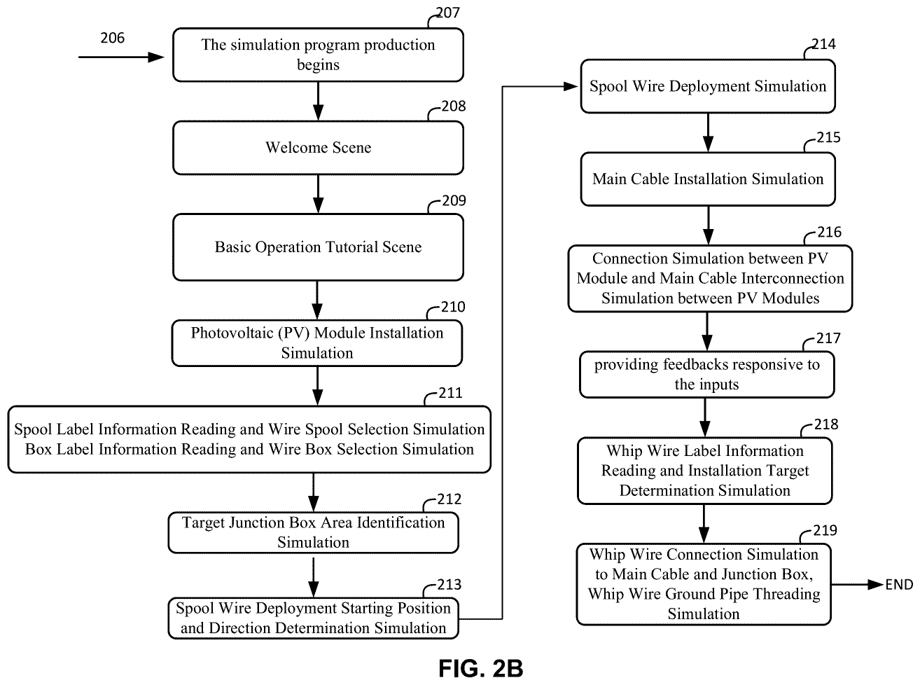

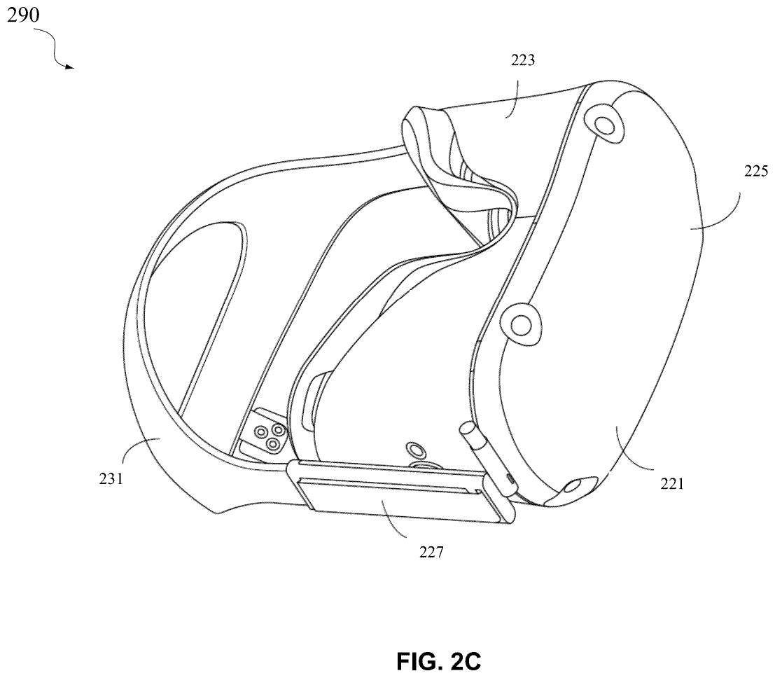

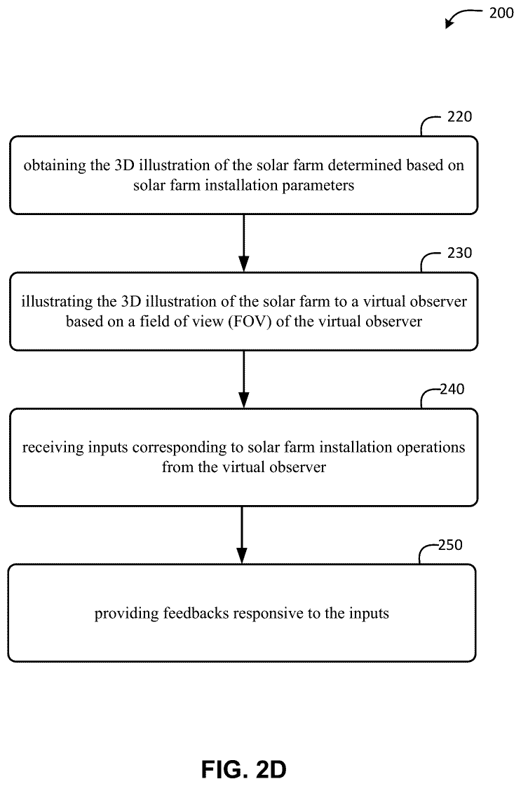

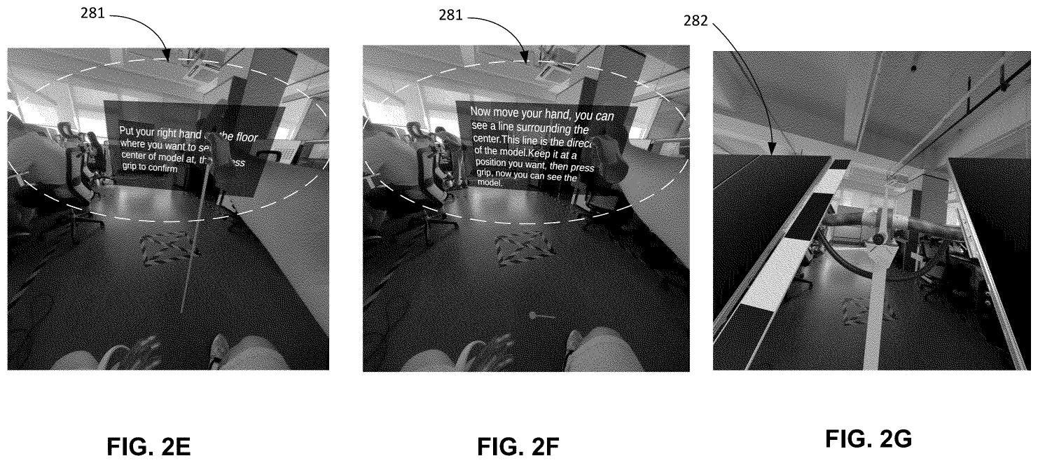

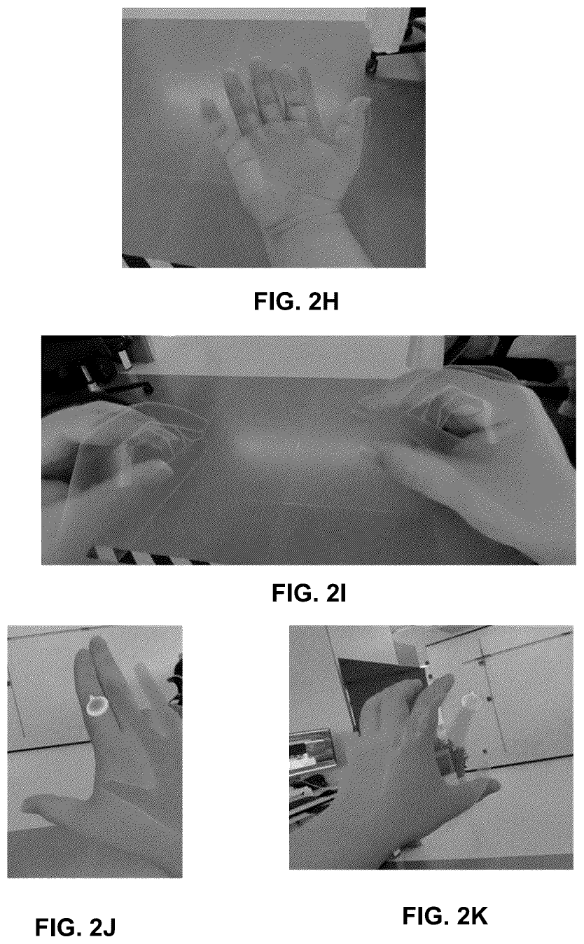

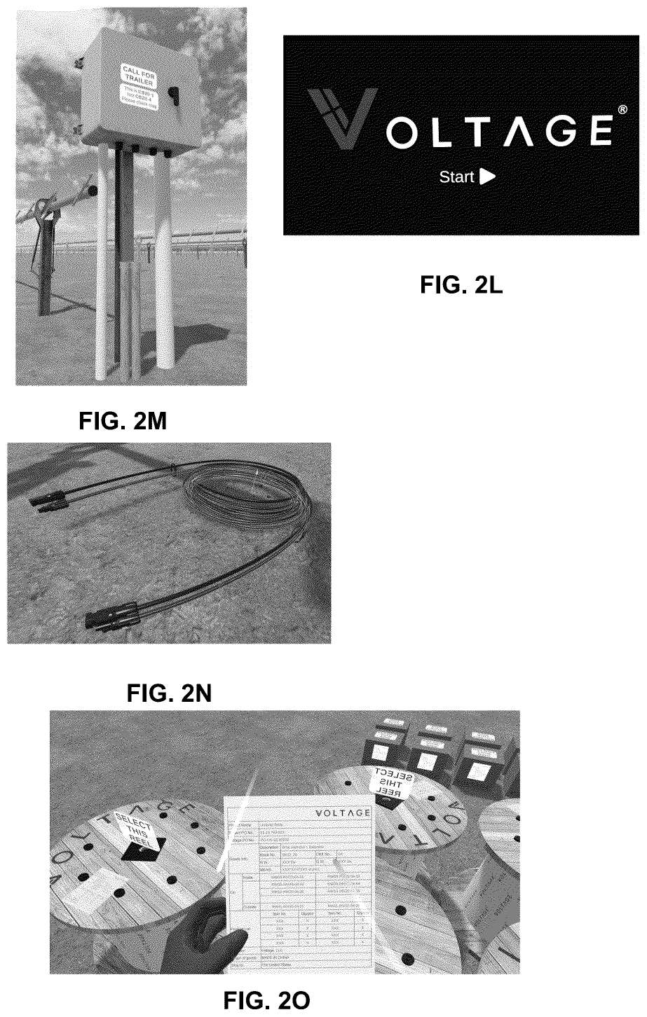

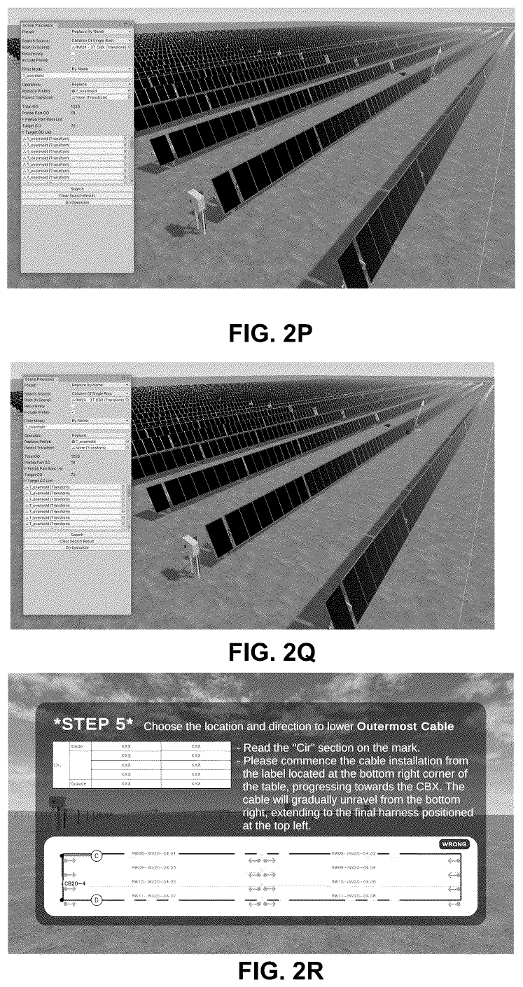

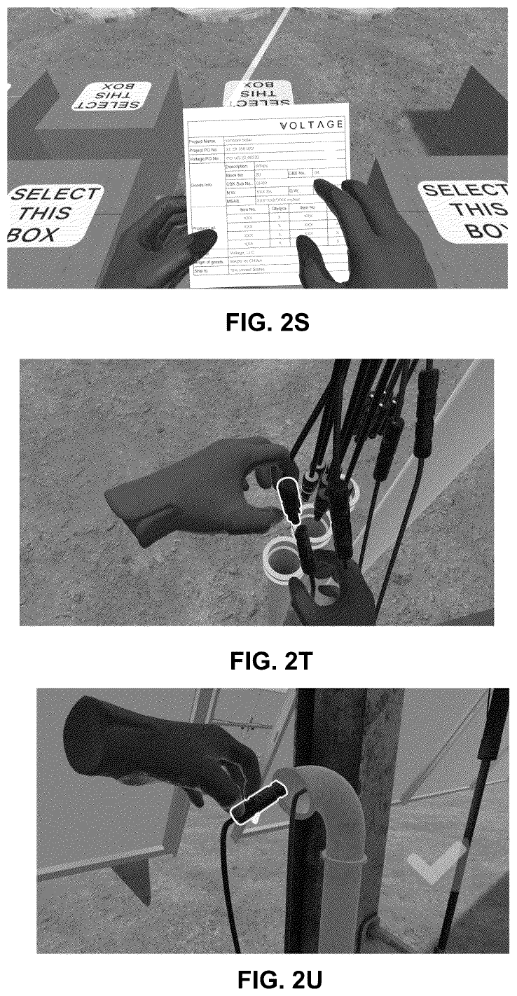

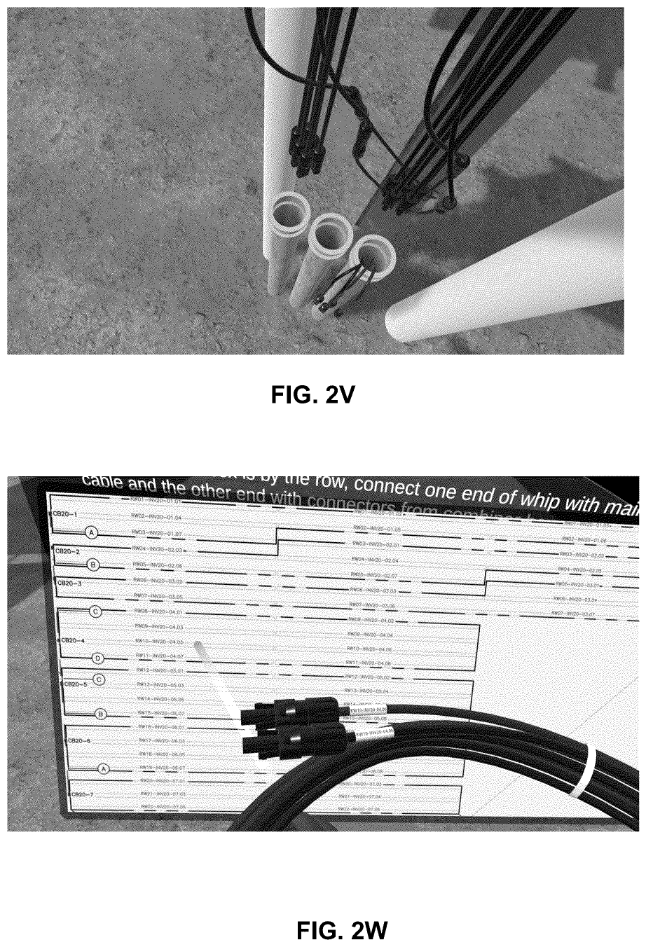

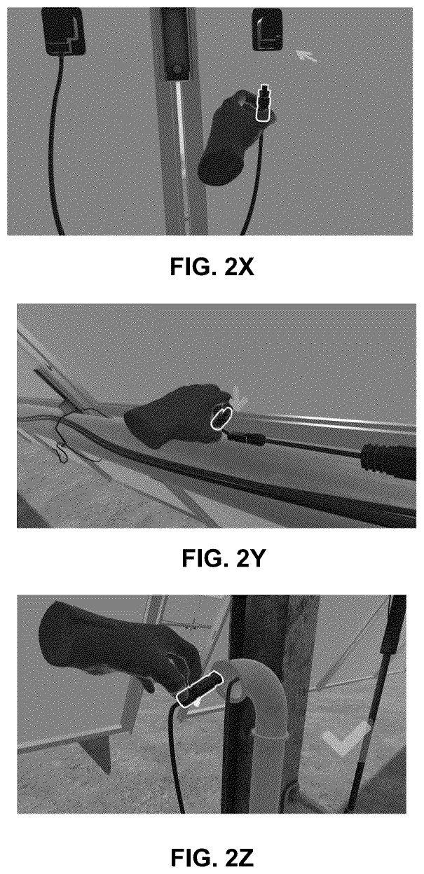

FIGS. 2A-2B are block diagrams for assisting solar farm installation using a 3D illustration of the solar farm, according to some embodiments. The structure for performing the functionality illustrated in one or more of the blocks shown in FIGS. 2A and 2B may be performed by hardware and/or software components of a computerized apparatus or system. Components of such computerized apparatus or system may include, for example, one or more processors, one or more controllers, a computerized system, or a computer-readable apparatus including a storage medium storing computer-readable and/or computer-executable instructions that are configured to, when executed by one or more processors, cause the one or more processors or a computerized apparatus to perform the operations. Example components of a computer system are illustrated in FIG. 7, which are described in more detail below.

At block 201, the photovoltaic power station design diagram is provided by the customer.

At block 202, the simulation program production begins.

At block 203, Establish a three-dimensional layout of the photovoltaic power station, create models, apply textures, and other artistic assets.

At block 204, Import the three-dimensional layout of the power station and artistic assets into the Unity project, then fill the scene with artistic assets and optimize performance.

At block 205, Based on the actual conditions of the photovoltaic power station, formulate and implement interactive step-by-step procedures, and create the necessary UI.

At block 206, Input the executable program package.

At block 207, The simulation program production begins.

At block 208, Welcome Scene shows.

At block 209, Basic Operation Tutorial Scene shows.

At block 210, Photovoltaic (PV) Module Installation Simulation is performed.

At block 211, Spool Label Information Reading and Wire Spool Selection and Simulation Box Label Information Reading and Wire Box Selection Simulation are performed.

At block 212, Target Junction Box Area Identification Simulation is performed.

At block 213, Spool Wire Deployment Starting Position and Direction Determination Simulation are performed.

At block 214, Spool Wire Deployment Simulation is performed.

At block 215, Main Cable Installation Simulation is performed.

At block 216, Connection Simulation between PV Module and Main Cable Interconnection Simulation between PV Modules is performed.

At block 217, providing feedbacks responsive to the inputs is performed.

At block 218, Whip Wire Label Information Reading and Installation Target Determination Simulation.

At block 219, Whip Wire Connection Simulation to Main Cable and Junction Box, Whip Wire Ground Pipe Threading Simulation.

FIG. 2C is a perspective view of an example of a near-eye display in the form of an HMD device 290 for implementing some of the examples disclosed herein. HMD device 290 may be a part of, e.g., a VR system, an AR system, an MR system, or any combination thereof. HMD device 290 may include a body 221 and a head strap 231. FIG. 2 shows a bottom side 223, a front side 225, and a left side 227 of body 221 in the perspective view. Head strap 231 may have an adjustable or extendible length. There may be a sufficient space between body 221 and head strap 231 of HMD device 290 for allowing a user to mount HMD device 290 onto the user's head. In various embodiments, HMD device 290 may include additional, fewer, or different components. For example, in some embodiments, HMD device 290 may include eyeglass temples and temple tips, rather than head strap 231.

HMD device 290 may present to a user media including virtual and/or augmented views of a physical, real-world environment with computer-generated elements. Examples of the media presented by HMD device 290 may include images (e.g., two-dimensional (2D) or three-dimensional (3D) images), videos (e.g., 2D or 3D videos), audio, or any combination thereof. The images and videos may be presented to each eye of the user by one or more display assemblies (not shown in FIG. 2) enclosed in body 221 of HMD device 290. In various embodiments, the one or more display assemblies may include a single electronic display panel or multiple electronic display panels (e.g., one display panel for each eye of the user). Examples of the electronic display panel(s) may include, for example, an LCD, an OLED display, an ILED display, a μLED display, an AMOLED, a TOLED, some other display, or any combination thereof. HMD device 290 may include two eye box regions.

In some implementations, HMD device 290 may include various sensors (not shown), such as depth sensors, motion sensors, position sensors, and eye tracking sensors. Some of these sensors may use a structured light pattern for sensing. In some implementations, HMD device 290 may include an input/output interface for communicating with a console. In some implementations, HMD device 290 may include a virtual reality engine (not shown) that can execute applications within HMD device 290 and receive depth information, position information, acceleration information, velocity information, predicted future positions, or any combination thereof of HMD device 290 from the various sensors. In some implementations, the information received by the virtual reality engine may be used for producing a signal (e.g., display instructions) to the one or more display assemblies. In some implementations, HMD device 290 may include locators (not shown) located in fixed positions on body 221 relative to one another and relative to a reference point. Each of the locators may emit light that is detectable by an external imaging device.

FIG. 2D is a flow diagram of a method 200 for assisting photovoltaic panel array current distribution wiring system installation using a 3D illustration of the photovoltaic panel array current distribution wiring system, according to some embodiments. The structure for performing the functionality illustrated in one or more of the blocks shown in FIG. 2D may be performed by hardware and/or software components of a computerized apparatus or system. Components of such computerized apparatus or system may include, for example, one or more processors, one or more controllers, a computerized system, or a computer-readable apparatus including a storage medium storing computer-readable and/or computer-executable instructions that are configured to, when executed by one or more processors, cause the one or more processors or a computerized apparatus to perform the operations. Example components of a computer system are illustrated in FIG. 7, which are described in more detail below.

At block 220, the functionality may include obtaining the 3D illustration of the solar farm determined based on solar farm installation parameters.

At step 230, the functionality may include illustrating the 3D illustration of the solar farm to a virtual observer based on a field of view (FOV) of the virtual observer.

At step 240, the functionality may include receiving inputs corresponding to solar farm installation operations from the virtual observer.

At step 250, the functionality may include providing feedback responsive to the inputs.

In some embodiments, the solar farm installation operations comprise installing a photovoltaic module in corresponding positions on brackets.

In some embodiments, the solar farm installation operations comprise selecting appropriate tool for performing the solar farm installation operations.

In some embodiments, the appropriate tool comprises a wire spool, a wire box, or both.

In some embodiments, the operations further include in response to the inputs being correct, providing a first response; and in response to the inputs being incorrect, providing a second response, different from the first response, wherein whether the inputs are correct is determined based on predetermined rules.

In some embodiments, the first and second responses comprises sound effects, text prompt, vibration, or any combination thereof.

FIGS. 2E-2G show examples UIs for photovoltaic panel array current distribution wiring system installation training, according to some embodiments. As shown in FIGS. 2E and 2F, instructions 281 may show in front of the virtual observer/user. After the virtual observer/user properly followed the instructions, the component to be installed (e.g., photovoltaic panel 282) may show. Further instructions may pop-out.

FIGS. 2H-2Z further show examples UIs for photovoltaic panel array current distribution wiring system installation training, according to some embodiments.

Solution C: 3D illustration of a real-world photovoltaic cable manufacturing facility (e.g., factory). The technical solution disclosed herein may be used by potential customer to inspect photovoltaic cable manufacturing facility in a different location (e.g., remotely) and/or to observe the production process of photovoltaic cables performed by the photovoltaic cable manufacturing facility. In some embodiments, after wearing VR equipment and launching the 360° roaming software, customers can achieve a 360° panoramic tour of the photovoltaic cable manufacturing facility.

For example, a photovoltaic cable manufacturing facility may be examined using a 360° panoramic camera to capture the equipment and processes involved in the production of photovoltaic cables. After the image and/or video capturing is completed, image and/or video software may be used to edit the 360°panoramic images/videos, removing any text information. a 360° panoramic roaming application may be determined on a 2D/3D real-time development platform to achieve the effect of touring the factory.

As a non-limiting example, the customer (e.g., the virtual observer) puts on the VR device, launches the 360° roaming software, and enters a 360° panoramic tour of the cable manufacturing factory. Customers first enter a predetermined panoramic image of a section of the factory. The customers can then observe the internal structure of the factory in 360°, as if they are physically present inside the factory. Virtual portals are set up at locations where the scene transitions in the virtual factory. Customers can use the VR device's controller to aim and click on these portals, allowing them to transport to the next scene. The factory is divided into multiple areas. To facilitate customer navigation through different sections, a simple map for each area of the factory may be created. By pressing a button on the controller, customers can pull up a menu that displays the various regions of the factory, detailing the specific operations carried out in each. Customers can choose which factory area they wish to explore. After selecting a specific factory area, a simplified map of that region will be displayed. This map showcases the equipment and processes involved in cable production for that area, important scene transition portals, and also indicates the customer's current location within that area. Customers can choose a specific equipment or process from the map, click on its corresponding portal, and be instantly transported to that scene.

The 3D illustration may indicate factory production scale (number of production lines), the complete process from raw materials to finished products, and production equipment management. The 3D illustration may also indicate factory layout (division of workshops/warehouse areas), on-site environment and atmosphere, 5S management, and safety management. Laboratory environment, testing equipment related to photovoltaic cable industry standards, and testing procedures may also be illustrated. For example, when users are at the photovoltaic cable equipment or process section within the virtual factory (3D illustration of the real-world photovoltaic cable manufacturing facility), the technical solution disclosed herein may automatically pop-up detailed information about that equipment or process near its location.

In some embodiments, in the production of photovoltaic cable conductors, insulation extrusion, and harness assembly, key steps are presented in a 360-degree panorama. Customers can click on the teleport points to view these key steps in sequence. Additionally, the technical solution disclosed herein may set up a video playback button at the critical steps of the photovoltaic cable production. When customers click on the button, they can watch the process video of the key steps in a 360-degree panoramic view.

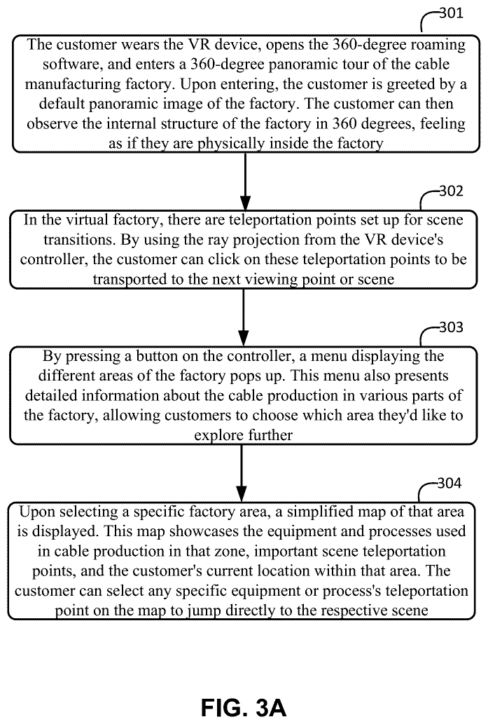

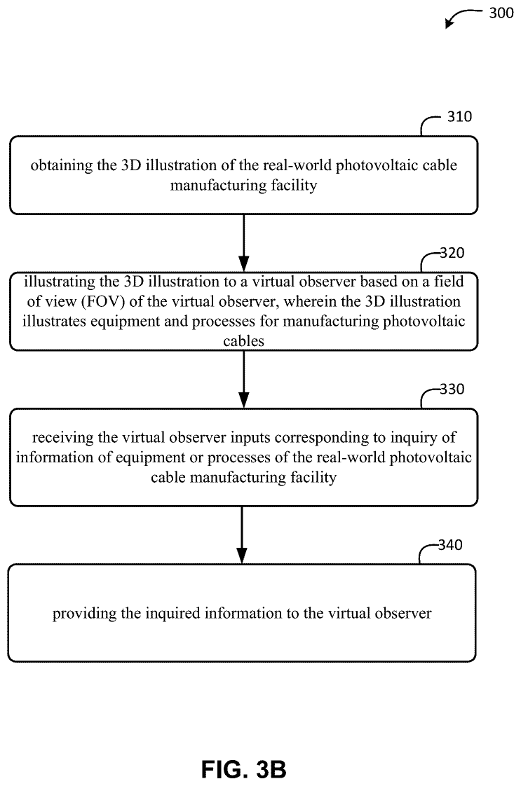

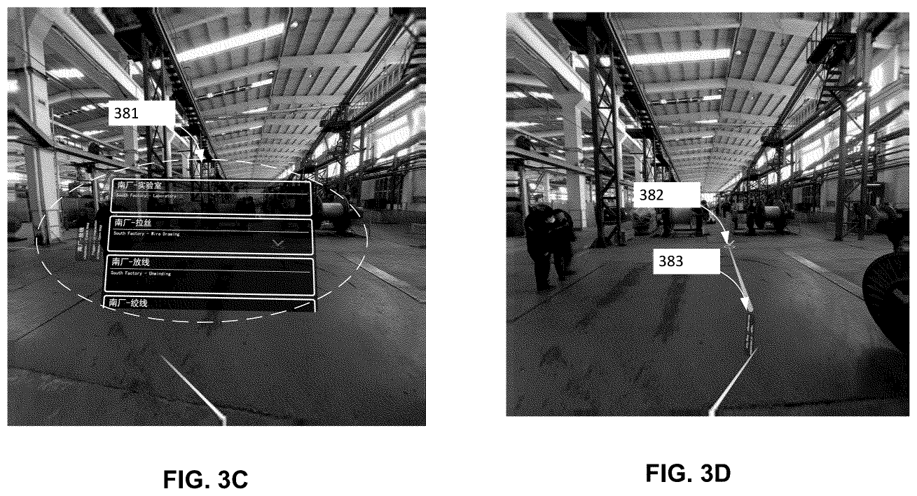

FIG. 3A is a block diagram for 3D illustration of a real-world photovoltaic cable manufacturing facility, according to some embodiments. Structure for performing the functionality illustrated in one or more of the blocks shown in FIG. 3A may be performed by hardware and/or software components of a computerized apparatus or system. Components of such computerized apparatus or system may include, for example, one or more processors, one or more controllers, a computerized system, or a computer-readable apparatus including a storage medium storing computer-readable and/or computer-executable instructions that are configured to, when executed by one or more processors, cause the one or more processors or a computerized apparatus to perform the operations. Example components of a computer system are illustrated in FIG. 7, which are described in more detail below.

At block 301, The customer wears the VR device, opens the 360-degree roaming software, and enters a 360-degree panoramic tour of the cable manufacturing factory. Upon entering, the customer is greeted by a default panoramic image of the factory. The customer can then observe the internal structure of the factory in 360 degrees, feeling as if they are physically inside the factory.

At block 302, In the virtual factory, there are teleportation points set up for scene transitions. By using the ray projection from the VR device's controller, the customer can click on these teleportation points to be transported to the next viewing point or scene.

At block 303, By pressing a button on the controller, a menu displaying the different areas of the factory pops up. This menu also presents detailed information about the cable production in various parts of the factory, allowing customers to choose which area they'd like to explore further.

At block 304, Upon selecting a specific factory area, a simplified map of that area is displayed. This map showcases the equipment and processes used in cable production in that zone, important scene teleportation points, and the customer's current location within that area. The customer can select any specific equipment or process's teleportation point on the map to jump directly to the respective scene.

FIG. 3B is a flow diagram of a method 300 for 3D illustration of a real-world photovoltaic cable manufacturing facility, according to some embodiments. Structure for performing the functionality illustrated in one or more of the blocks shown in FIG. 3B may be performed by hardware and/or software components of a computerized apparatus or system. Components of such computerized apparatus or system may include, for example, one or more processors, one or more controllers, a computerized system, or a computer-readable apparatus including a storage medium storing computer-readable and/or computer-executable instructions that are configured to, when executed by one or more processors, cause the one or more processors or a computerized apparatus to perform the operations. Example components of a computer system are illustrated in FIG. 7, which are described in more detail below.

At block 310, the functionality may include obtaining the 3D illustration of the real-world photovoltaic cable manufacturing facility.

At step 320, the functionality may include illustration to a virtual observer based on a field of view (FOV) of the virtual observer, wherein the 3D illustration illustrates equipment and processes for manufacturing photovoltaic cables.

At step 330, the functionality may include the virtual observer inputs corresponding to inquiry of information of equipment or processes of the real-world photovoltaic cable manufacturing facility.

At step 340, the functionality may include providing the inquired information to the virtual observer.

In some embodiments, obtaining the 3D illustration of the real-world photovoltaic cable manufacturing facility comprise capturing media assets of the real-world photovoltaic cable manufacturing facility using a 360° panoramic camera.

For example, FIGS. 3C and 3D show examples of 3D illustration of the real-world photovoltaic cable manufacturing facility, according to some embodiments. As shown in FIG. 3C, information regarding the equipment and/or manufacturing processes may show when the FOV of the virtual observer is covering the equipment. As shown in FIG. 3D, the customer/virtual observer can select any specific equipment or process's teleportation point 383 on the map to jump directly to the respective scene follow e.g., by path 383.

In some embodiments, the 3D illustration is illustrated using a virtual reality device.

Solution D: Assisting solar farm installation using a three-dimensional (3D) illustration of the solar farm. The technical solution disclosed herein may allow simulating typical bracket component on-site scenarios where multiple customers/user/virtual observers may simultaneously cooperate and/or operate on a same 3D modeling project and achieving real-time interaction within the virtual model scene of typical bracket components.

The technical solution disclosed herein may allow: (1) Measuring cable length: Users can measure the cable length within the scene using a cable length detector that follows hand movements. The measured cable length will be displayed above the detector, and the measured cable will be tinted a corresponding color. If there are other users in the room (e.g., on the virtual cite), the cable lengths they measure will be displayed sequentially below the detector. For example, upon entering the virtual world, users will find a cable length detector floating in the palm of their left hand. Move the left hand to make the head of the detector touch the cable. The color of the cable will change, indicating that the cable is detectable. By pressing the trigger button on the left-hand controller, the length of the cable can be read. The measured length will be displayed above the detector, and the cable's color will change to the unique color assigned to that user. Each user in the world is assigned a distinct color for differentiation. If there are multiple users present simultaneously, the usernames and measured cable lengths of users other than the host will be displayed in text form below the detector, tinted in their assigned colors.

(2) Eye-tracking facial capture: Real-time tracking of the user's facial expressions, synchronized to an online virtual world platform. for example, wearing a VR device that supports eye-tracking facial capture (such as Pico4 pro), and with the support of the Pico4 pro's official streaming software-Game Streaming Assistant and VRCFaceTracking software, users enter the “Multi-Person Cable Length Detection” scene in VRChat. Once inside, the eye-tracking facial capture feature is automatically activated, tracking users' facial movements in real-time and synchronizing them to their avatars in VRChat, making interactions between users feel more authentic and natural. The eye-tracking may be used for determining the FOV of the user/virtual observer.

In some embodiments, the Eye-tracking may be performed based on any of the followings: [1] Pupil Center: The central point of the pupil is tracked to determine where a person is looking. Algorithms then map this point onto the screen or scene to identify the gaze location. [2] Corneal Reflection: This is the primary method used in video-based eye trackers. Infrared light sources are directed towards the eye, creating reflections on the cornea (the outermost layer of the eye). By comparing the relative positions of the pupil center and the corneal reflection, the system can deduce the direction of gaze. [3] Pupil Size: Some eye trackers measure the diameter or size of the pupil, which can change due to factors like arousal, cognitive workload, or changes in lighting. [4] Changes in pupil size (pupillometry) can be indicative of a person's emotional or cognitive state. [5] Saccades: These are rapid eye movements that occur when a person shifts their gaze from one location to another. By tracking saccades, researchers can gain insight into reading patterns, information processing, or attention shifts. [6] Fixations: A fixation occurs when the gaze lingers in one location for a certain amount of time. The duration and location of fixations can give insights into what is capturing a person's attention or what they're processing. [7] Blink Rate and Duration: Some systems also track blink patterns, which can be influenced by factors like fatigue or cognitive load.

(3) Avatar accessories: Users can choose to put on or take off accessories from the wheel menu, enhancing the interactivity and fun within the online virtual world platform. For example, wearing a VR device (e.g., Pico4 pro), users enter the “Multi-Person Cable Length Detection” scene in VRChat. By long-pressing the controller button, a wheel menu will pop up. Select the “Expression” option to access the Expression submenu. This submenu offers toggle options for different accessories (e.g., safety helmets, safety suits). Pressing the toggle for a particular accessory will equip that item to the user's avatar in the scene, enhancing user interactivity and realism.

(4) Paintbrush: Users can use the paintbrush to mark typical bracket component models within the online virtual world platform scene. For example, wearing a VR device (e.g., Pico4 pro), users enter the “Multi-Person Cable Length Detection” scene in VRChat. By pressing the grab button on the right-hand controller, a paintbrush UI will appear. Clicking on the paintbrush logo within this UI will produce a paintbrush directly in front of the user's avatar. The user can use the controller's action and grab buttons to paint, marking typical bracket component models within the scene and enhancing user interactivity. If a user wishes to erase their drawings, they can open the paintbrush UI again and select the eraser logo to delete their strokes.

According to the technical solution disclosed herein, the feature for measuring cable length may be specifically designed for the photovoltaic industry. During the installation of photovoltaic cables, customers need to accurately measure the length of the cables to determine the exact amount of cable required. In the virtual world platform scene, customers can personally measure the length of different cables on a typical bracket, gaining the most authentic feel for each section of cable length while also enhancing interactivity and enjoyment.

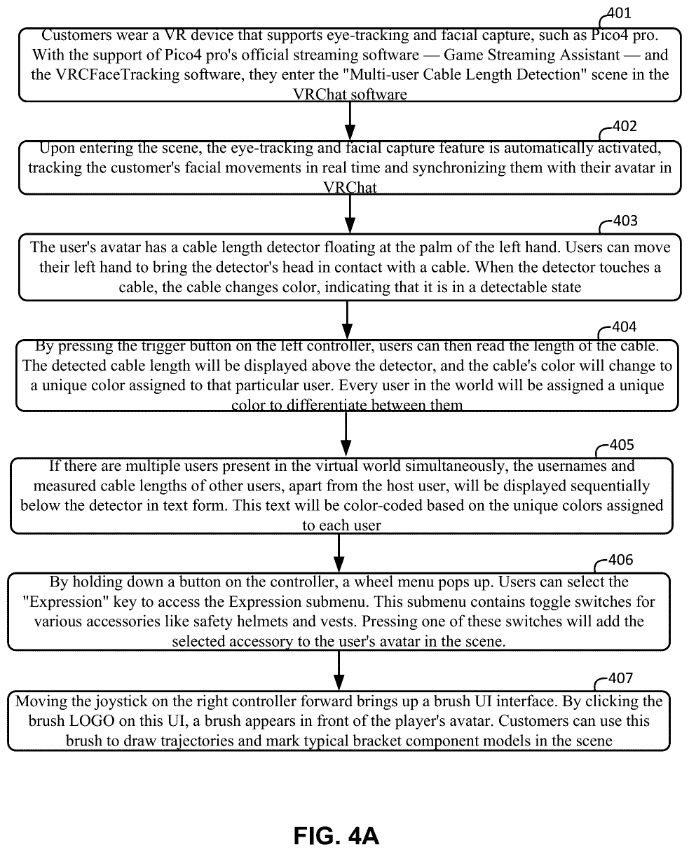

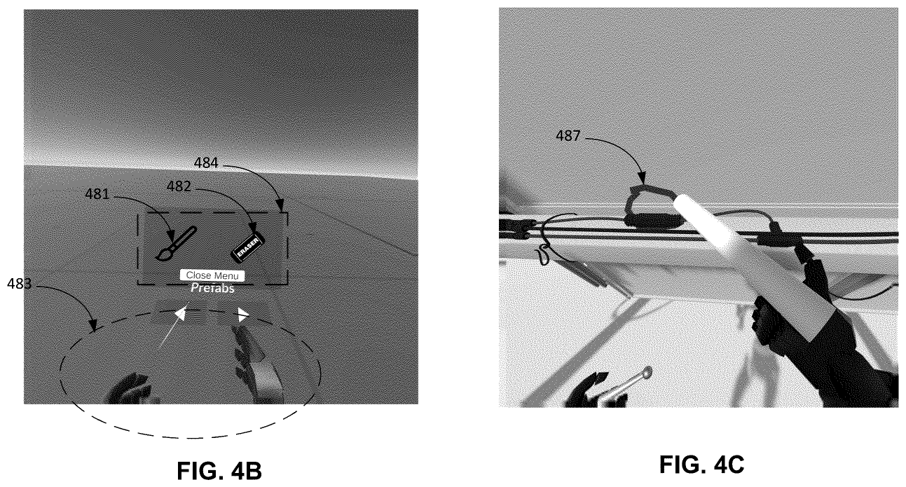

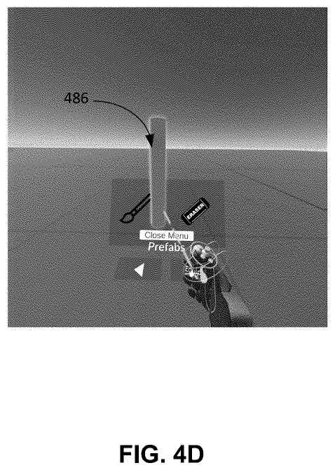

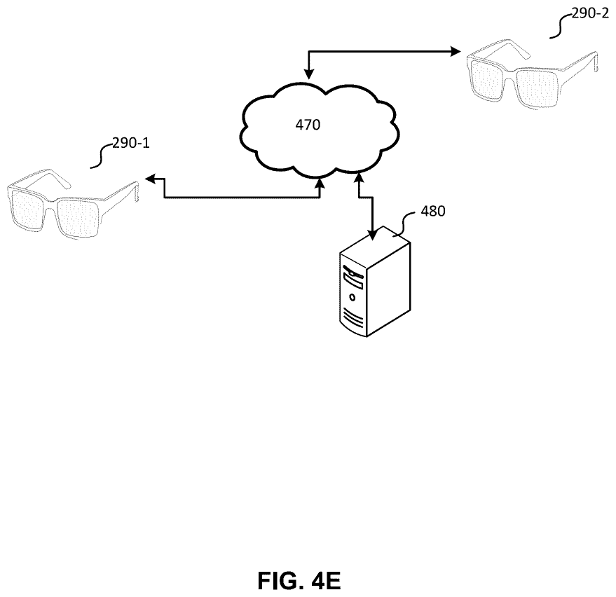

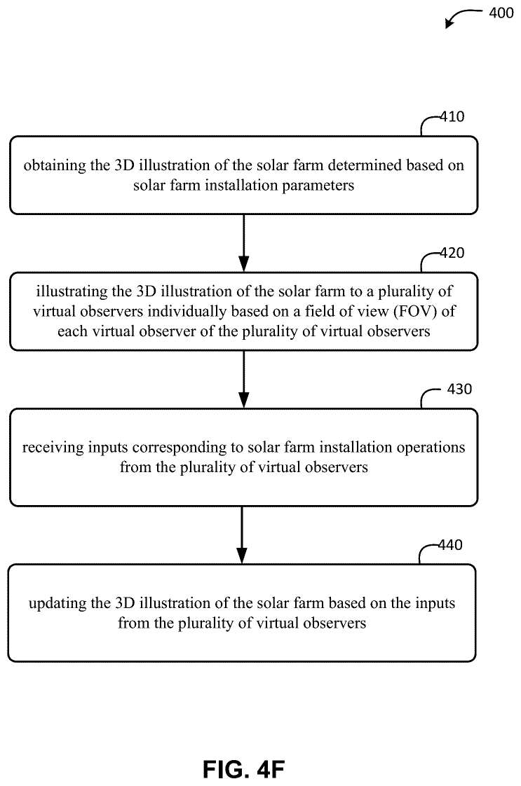

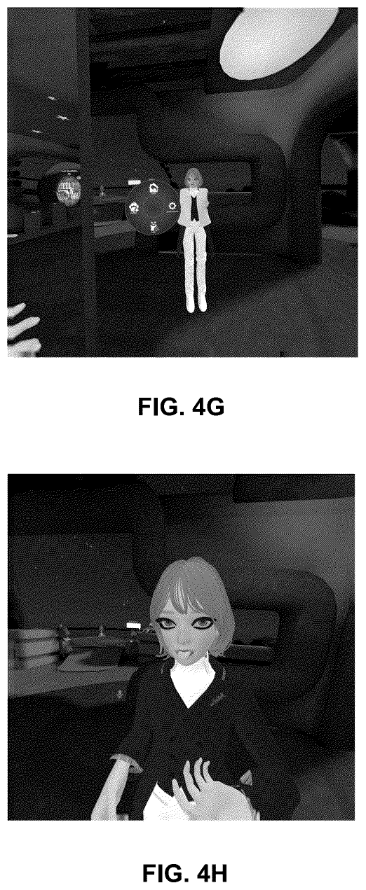

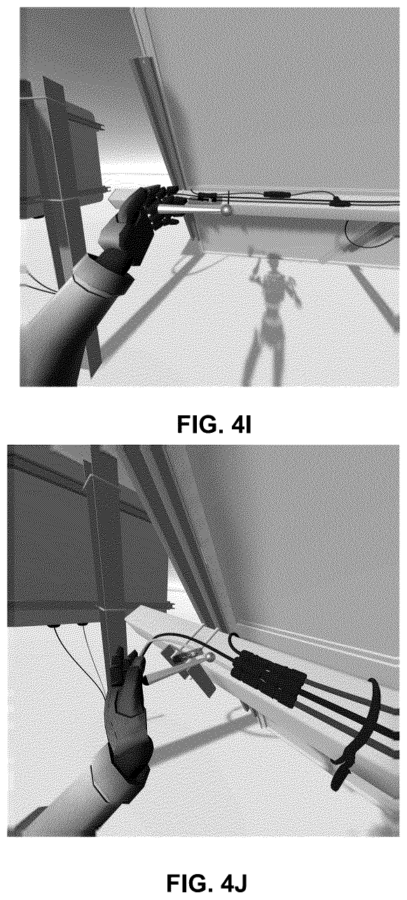

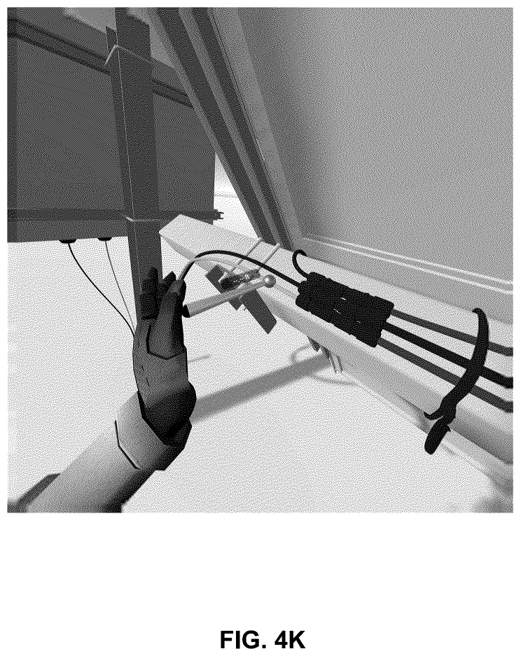

FIG. 4A is a block diagram for assisting solar farm installation using a 3D illustration of the solar farm. Structure for performing the functionality illustrated in one or more of the blocks shown in FIG. 4A may be performed by hardware and/or software components of a computerized apparatus or system. Components of such computerized apparatus or system may include, for example, one or more processors, one or more controllers, a computerized system, or a computer-readable apparatus including a storage medium storing computer-readable and/or computer-executable instructions that are configured to, when executed by one or more processors, cause the one or more processors or a computerized apparatus to perform the operations. Example components of a computer system are illustrated in FIG. 7, which are described in more detail below.

At block 401, Customers wear a VR device that supports eye-tracking and facial capture, such as Pico4 pro. With the support of Pico4 pro's official streaming software-Game Streaming Assistant-and the VRCFaceTracking software, they enter the “Multi-user Cable Length Detection” scene in the VRChat software.

At block 402, Upon entering the scene, the eye-tracking and facial capture feature is automatically activated, tracking the customer's facial movements in real time and synchronizing them with their avatar in VRChat.

At block 403, The user's avatar has a cable length detector floating at the palm of the left hand. Users can move their left hand to bring the detector's head in contact with a cable. When the detector touches a cable, the cable changes color, indicating that it is in a detectable state.

At block 404, By pressing the trigger button on the left controller, users can then read the length of the cable. The detected cable length will be displayed above the detector, and the cable's color will change to a unique color assigned to that particular user. Every user in the world will be assigned a unique color to differentiate between them.

At block 405, If there are multiple users present in the virtual world simultaneously, the usernames and measured cable lengths of other users, apart from the host user, will be displayed sequentially below the detector in text form. This text will be color-coded based on the unique colors assigned to each user.

At block 406, By holding down a button on the controller, a wheel menu pops up. Users can select the “Expression” key to access the Expression submenu. This submenu contains toggle switches for various accessories like safety helmets and vests. Pressing one of these switches will add the selected accessory to the user's avatar in the scene.

At block 407, Moving the joystick on the right controller forward brings up a brush UI interface. By clicking the brush LOGO on this UI, a brush appears in front of the player's avatar. Customers can use this brush to draw trajectories and mark typical bracket component models in the scene.

FIGS. 4B-4D show example UIs with brush and eraser according to some embodiments. For example, as shown in FIG. 4B, the brush 481 configured to paint (e.g., draw strokes 487 shown in FIG. 4C), marking typical bracket component models (e.g., bracket component model 485 shown in FIG. 486), and eraser 482 configured to delete their strokes may appears in the menu 484 front of the player's avatar 483.

FIG. 4E is a simplified illustration of a multiple commuting device communication system in which HMD 290, server 490, and/or other components of the communication system can use the techniques provided herein for simultaneously interacting in the 3D illustration of a photovoltaic panel array current distribution wiring system.

In some embodiments, server 490 may be the computing system configured to perform the technical solution disclosed herein. The one or more HMDs 290 may be used by one or more users/virtual reality observers at same or different locations. Through the network 170, server 490 and the one or more HMDs 290 may be connected and may communicate data. Depending on desired functionality, the network 470 may comprise any of a variety of wireless and/or wireline networks. The network 470 can, for example, comprise any combination of public and/or private networks, local and/or wide-area networks, and the like. Furthermore, the network 470 may utilize one or more wired and/or wireless communication technologies. In some embodiments, the network 470 may comprise a cellular or other mobile network, a wireless local area network (WLAN), a wireless wide-area network (WWAN), and/or the Internet, for example. Examples of network 470 include an LTE wireless network, a Fifth Generation (5G) wireless network (also referred to as an NR wireless network or 5G NR wireless network), a Wi-Fi WLAN, and the Internet. LTE, 5G and NR are wireless technologies defined, or being defined, by the 3rd Generation Partnership Project (3GPP). Network 470 may also include more than one network and/or more than one type of network. A person of ordinary skill in the art will recognize many modifications to the components illustrated.

FIG. 4F is a flow diagram of a method 400 for assisting solar farm installation using a 3D illustration of the solar farm, according to some embodiments. Structure for performing the functionality illustrated in one or more of the blocks shown in FIG. 4F may be performed by hardware and/or software components of a computerized apparatus or system. Components of such computerized apparatus or system may include, for example, one or more processors, one or more controllers, a computerized system, or a computer-readable apparatus including a storage medium storing computer-readable and/or computer-executable instructions that are configured to, when executed by one or more processors, cause the one or more processors or a computerized apparatus to perform the operations. Example components of a computer system are illustrated in FIG. 7, which are described in more detail below.

At block 410, the functionality may include obtaining the 3D illustration of the solar

farm determined based on solar farm installation parameters.

At step 420, the functionality may include illustration to a virtual observer based on a field of view (FOV) of the virtual observer, wherein the 3D illustration illustrates equipment and processes for manufacturing photovoltaic cables.

At step 430, the functionality may include receiving inputs corresponding to solar farm installation operations from the plurality of virtual observers.

At step 440, the functionality may include updating the 3D illustration of the solar farm based on the inputs from the plurality of virtual observers.

In some embodiments, the solar farm installation operations comprise measuring a length of cable used in the solar farm.

In some embodiments, illustrating the 3D illustration of the solar farm to a plurality of virtual observers individually further comprise tracking eye movements, facial expression, or both, of the virtual observer.

In some embodiments, inputs corresponding to solar farm installation operations comprise marking bracket component models illustrated in the 3D illustration of the solar farm.

FIGS. 4G-4L show example UIs for assisting solar farm installation using a 3D illustration of the solar farm, according to some embodiments.

Solution E: 3D illustration of a solar farm. The technical solution disclosed herein may be used to display virtual models to users/virtual observers within the current real space, and interaction is possible. The virtual observers may select the desired model, place the model at any location, interact with existing models, use model cross-section functionality, and mark boundary and obstacle.

In some embodiments, once the user/virtual observer puts on the headset and starts the application, the user will see the user's current real space and a pair of virtual interactive hands corresponding to the user's own hands (e.g., by tracking the hand movements of the user's real hands), indicating that the application has been successfully entered.

As a non-limiting example, upon entering the application, the user will see the current real environment through the device's lens, along with a pair of hand models that represent the user's hands. The user will use these virtual hands for operations. If a gesture functionality has been added, the virtual hands will synchronize with our real hand gestures, allowing users to complete tasks using predefined gestures. Next, the user can choose the scene and model the user want to view and place the scene and model anywhere, such as in a simulation setting or a small adapter cable model. Similarly, the user can interact with any object in the scene, such as grabbing. For example, the user may use the virtual hand to perform inspection of the details of the wire connectors (e.g., connecting trunk wires with brunch wires, such as a trunk bus), and then connecting the connectors. For example, the connectors can be between aluminum (Al) wire to Al wire, Al wire to copper (Cu) wire, and/or Cu wire to Cu wires. The connectors may be trunk buses connecting trunk wires with brunch wires. For larger models like big brackets, the application offers a cross-section function. Users can freely move the bracket to observe the cross-sectional details of the component the user wish to see.

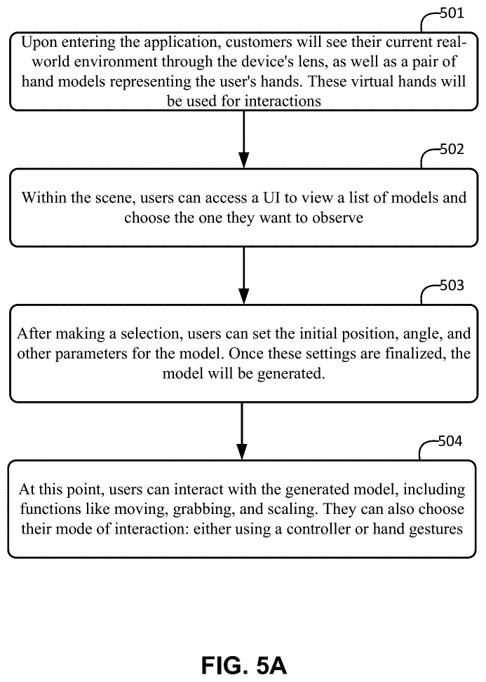

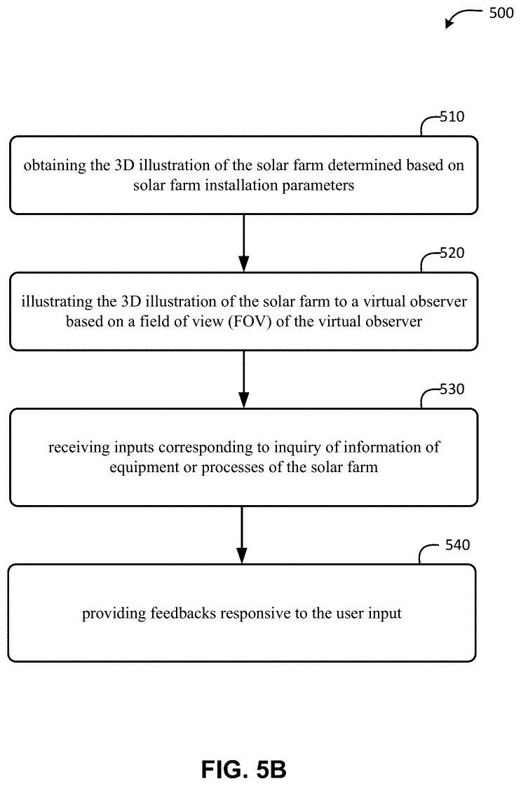

FIG. 5A is a flow diagram of 3D illustration of a method 500 for a solar farm. Structure for performing the functionality illustrated in one or more of the blocks shown in FIG. 5A may be performed by hardware and/or software components of a computerized apparatus or system. Components of such computerized apparatus or system may include, for example, one or more processors, one or more controllers, a computerized system, or a computer-readable apparatus including a storage medium storing computer-readable and/or computer-executable instructions that are configured to, when executed by one or more processors, cause the one or more processors or a computerized apparatus to perform the operations. Example components of a computer system are illustrated in FIG. 7, which are described in more detail below.

At block 501, Upon entering the application, customers will see their current real-world environment through the device's lens, as well as a pair of hand models representing the user's hands. These virtual hands will be used for interactions.

At block 502, Within the scene, users can access a UI to view a list of models and choose the one they want to observe.

At block 503, After making a selection, users can set the initial position, angle, and other parameters for the model. Once these settings are finalized, the model will be generated.

At block 504, At this point, users can interact with the generated model, including functions like moving, grabbing, and scaling. They can also choose their mode of interaction: either using a controller or hand gestures.

FIG. 5B is a flow diagram of 3D illustration of a method 500 for a solar farm. Structure for performing the functionality illustrated in one or more of the blocks shown in FIG. 5B may be performed by hardware and/or software components of a computerized apparatus or system. Components of such computerized apparatus or system may include, for example, one or more processors, one or more controllers, a computerized system, or a computer-readable apparatus including a storage medium storing computer-readable and/or computer-executable instructions that are configured to, when executed by one or more processors, cause the one or more processors or a computerized apparatus to perform the operations. Example components of a computer system are illustrated in FIG. 7, which are described in more detail below.

At block 510, the functionality may include obtaining the 3D illustration of the solar farm determined based on solar farm installation parameters.

At step 520, the functionality may include illustrating the 3D illustration of the solar farm to a virtual observer based on a field of view (FOV) of the virtual observer.

At step 530, the functionality may include receiving inputs corresponding to inquiry of information of equipment or processes of the solar farm.

At step 540, the functionality may include providing feedback responsive to the user input.

In some embodiments, the inputs further comprise requesting a cross-sectional detail of a component of the solar farm.

In some embodiments, the inputs are received through tracking hand movements of the virtual observer.

In some embodiments, inputs corresponding to solar farm installation operations comprise marking bracket component models illustrated in the 3D illustration of the solar farm.

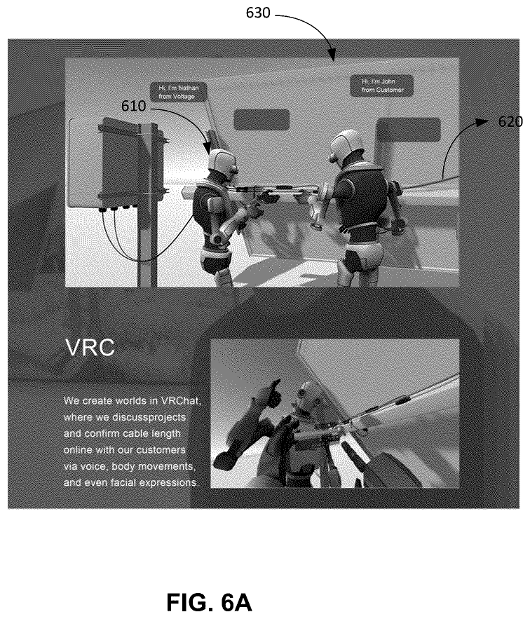

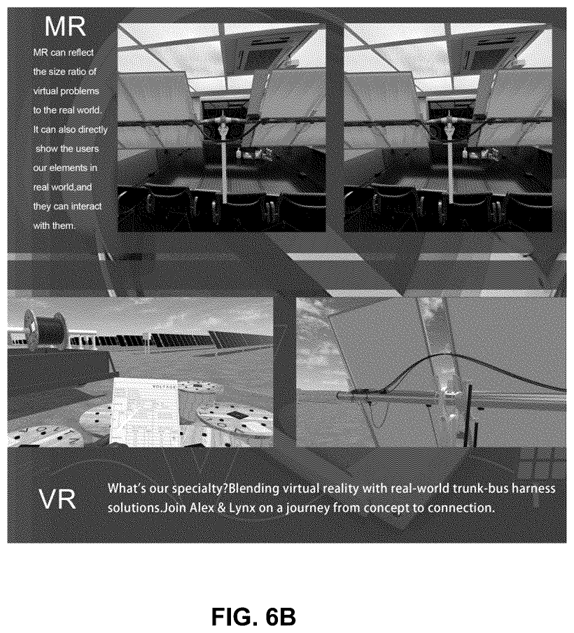

FIGS. 6A and 6B illustrate example UIs of the 3D illustration, according to some embodiments. The UIs may be shown in any of the solutions disclosed herein. As shown in FIG, 6A, the UI shows Avatars 610 interacting/cooperating with each other, operating on photovoltaic cables 620 and photovoltaic panels 630.

FIG. 7 is a block diagram of an embodiment of a computer system 700, which may be used, in whole or in part, to provide the functions of one or more components and/or devices as described in the embodiments herein. This may include, for example, a computer server, personal computer, personal electronic device, or the like. It should be noted that FIG. 7 is meant only to provide a generalized illustration of various components, any or all of which may be utilized as appropriate. FIG. 7, therefore, broadly illustrates how individual system elements may be implemented in a relatively separated or relatively more integrated manner. In addition, it can be noted that components illustrated by FIG. 7 can be localized to a single device and/or distributed among various networked devices, which may be disposed at different geographical locations.

The computer system 700 is shown comprising hardware elements that can be electrically coupled via a bus 705 (or may otherwise be in communication, as appropriate). The hardware elements may include processor(s) 710, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 700 also may comprise one or more input devices 715, which may comprise without limitation a mouse, a keyboard, a camera, a microphone, and/or the like; and one or more output devices 720, which may comprise without limitation a display device, a printer, and/or the like.

The computer system 700 may further include (and/or be in communication with) one or more non-transitory storage devices 725, which can comprise, without limitation, local and/or network accessible storage, and/or may comprise, without limitation, a disk drive, a drive array, an optical storage device, a solid-state storage device, such as a random-access memory (RAM) and/or read-only memory (ROM), which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 700 may also include a communications subsystem 730, which may comprise wireless communication technologies managed and controlled by a wireless communication interface 733, as well as wired technologies (such as Ethernet, coaxial communications, universal serial bus (USB), and the like). The wireless communication interface 733 may comprise one or more wireless transceivers that may send and receive wireless signals 755 (via wireless antenna(s) 750. Thus the communications subsystem 730 may comprise a modem, a network card (wireless or wired), an infrared communication device, a wireless communication device, and/or a chipset, and/or the like, which may enable the computer system 700 to communicate on any or all of the communication networks described herein to any device on the respective network, including a User Equipment (UE), a virtual or augmented or mixed reality device, and/or any other electronic devices described herein. Hence, the communications subsystem 730 may be used to receive and send data as described in the embodiments herein.

In many embodiments, the computer system 700 will further comprise a working memory 735, which may comprise a RAM or ROM device, as described above. Software elements, shown as being located within the working memory 735, may comprise an operating system 740, device drivers, executable libraries, and/or other code, such as one or more applications 745, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 725 described above. In some cases, the storage medium might be incorporated within a computer system, such as computer system 700. In other embodiments, the storage medium might be separate from a computer system (e.g., a removable medium, such as an optical disc), and/or provided in an installation package, such that the storage medium can be used to program, configure, and/or adapt a general-purpose computer with the instructions/code stored thereon. These instructions might take the form of executable code, which is executable by the computer system 700 and/or might take the form of source and/or installable code, which, upon compilation and/or installation on the computer system 700 (e.g., using any of a variety of generally available compilers, installation programs, compression/decompression utilities, etc.), then takes the form of executable code.

In some embodiments, the geo-fencing may also be performed in a cloud-base manner. For example, when a UE attempts an activity of interest (e.g., satellite messaging), restriction status applicable to the UE may be determined by a server based on the location of the UE (e.g., the position estimate determined by the UE along with the associated uncertainty) and satellite-related service parameters determined based on the unique identifier of the UE (e.g., International Mobile Equipment Identity (IMEI)). In some embodiments, the satellite-related service parameters may include a restriction applicability time window (e.g., during what time the restriction should be enforced), unique-identifier for devices to which the restrictions apply, applicable restrictions, or any combination thereof. As noted above, in some embodiments, the applicable restrictions may include whether satellite communication is allowed, transmit power level restrictions, whether satellite-based positioning is allowed or affected by intentional or unintentional interference, level of service allowed (e.g., whether only emergency calls are allowed or person-to-person messaging is also allowed), or any combination thereof.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1. An example method for generating a three-dimensional (3D) illustration of a photovoltaic panel array current distribution wiring system for photovoltaic panel array current distribution wiring system installation, comprising obtaining initial photovoltaic panel array current distribution wiring system installation parameters, determining the 3D illustration of the photovoltaic panel array current distribution wiring system based on the initial photovoltaic panel array current distribution wiring system installation parameters and information of a site environment of the photovoltaic panel array current distribution wiring system, and determining actual photovoltaic panel array current distribution wiring system installation parameters using the 3D illustration of the photovoltaic panel array current distribution wiring system.

Clause 2. The method of clause 1, wherein the initial photovoltaic panel array current distribution wiring system installation parameters comprise data from a bracket diagram, a wiring diagram, or both, determined for the photovoltaic panel array current distribution wiring system installation. Clause 3. The method of clause 1 or 2, wherein the data from the bracket diagram comprises: specifications for photovoltaic modules; dimensions of bracket motors; types and models of injection-molded parts; dimensions of clamps; types of hooks; pile position data; or any combination thereof.

Clause 4. The method of any clause of 1-3, wherein determining the 3D model illustration of the photovoltaic panel array current distribution wiring system further comprises: modeling components of the photovoltaic panel array current distribution wiring system, wherein the components comprise photovoltaic modules; positioning at least one of the modeled components; and connecting the photovoltaic modules.

Clause 5. The method of any clause of 1-4, wherein connecting the photovoltaic modules comprises series connections; jump connections; polarity connections; or any combination thereof.

Clause 6. The method of any clause of 1-5, wherein determining the 3D model illustration of the photovoltaic panel array current distribution wiring system further comprises: routing cables connecting at least some of the modeled components; and binding the cables according to on-site requirements.

Clause 7. The method of any clause of 1-6, wherein determining the 3D model illustration of the photovoltaic panel array current distribution wiring system further comprises: performing material mapping based on extracting textures through comparisons with images of actual site; performing model photography by simulating from various camera angles; and performing post-rendering adjustments.

Clause 8. The method of any clause of 1-7, wherein determining the actual photovoltaic panel array current distribution wiring system installation parameters further comprises: determining an actual total cable length for the photovoltaic panel array current distribution wiring system installation.

Clause 9. The method of any clause of 1-8, wherein the 3D illustration of the photovoltaic panel array current distribution wiring system comprises a 3D exclusive rendered video, a 3D exclusive page diagram, or both, wherein the 3D illustration of the photovoltaic panel array current distribution wiring system indicates the actual photovoltaic panel array current distribution wiring system installation parameters.

Clause 10. An example method for assisting photovoltaic panel array current distribution wiring system installation using a three-dimensional (3D) illustration of the photovoltaic panel array current distribution wiring system comprises obtaining the 3D illustration of the photovoltaic panel array current distribution wiring system determined based on photovoltaic panel array current distribution wiring system installation parameters, illustrating the 3D illustration of the photovoltaic panel array current distribution wiring system to a virtual observer based on a field of view (FOV) of the virtual observer, receiving inputs corresponding to photovoltaic panel array current distribution wiring system installation operations from the virtual observer, and providing feedback responsive to the inputs.

Clause 11. The method of clause 10, wherein the photovoltaic panel array current distribution wiring system installation operations comprise installing a photovoltaic module in corresponding positions on brackets.

Clause 12. The method of clause 10 or 11, wherein the appropriate tool comprises a wire spool, a wire box, or both.

Clause 13. The method of any clause of 10-12, wherein the photovoltaic panel array current distribution wiring system installation operations comprise selecting appropriate tool for performing the photovoltaic panel array current distribution wiring system installation operations.

Clause 14. The method of any clause of 10-13, wherein providing feedback responsive to the input further comprises: in response to the inputs being correct, providing a first response; and in response to the inputs being incorrect, providing a second response, different from the first response, wherein whether the inputs are correct is determined based on predetermined rules.

Clause 15. The method of any clause of 10-14, wherein the first and second responses comprises sound effects, text prompt, vibration, or any combination thereof.

Clause 16. An example method for three-dimensional (3D) illustration of a real-world photovoltaic cable manufacturing facility, comprises obtaining the 3D illustration of the real-world photovoltaic cable manufacturing facility, illustrating the 3D illustration to a virtual observer based on a field of view (FOV) of the virtual observer, wherein the 3D illustration illustrates equipment and processes for manufacturing photovoltaic cables, receiving the virtual observer inputs corresponding to inquiry of information of equipment or processes of the real-world photovoltaic cable manufacturing facility, and providing the inquired information to the virtual observer.

Clause 17. The method of clause 16, wherein the information of components of the real-world photovoltaic cable manufacturing facility comprises manufacturing processes performed on corresponding components.

Clause 18. The method of clause 16 or 17, wherein obtaining the 3D illustration of the real-world photovoltaic cable manufacturing facility comprises: capturing media assets of the real-world photovoltaic cable manufacturing facility using a 360° panoramic camera.

Clause 19. The method of any clause of 16-18, wherein the 3D illustration is illustrated using a virtual reality device.

Clause 20. The method of any clause of 16-19, wherein the 3D illustration indicates characteristics of the real-world photovoltaic cable manufacturing facility that comprises: a facility production scale; a facility layout; a facility on-site environment; management information; or any combination thereof.

Clause 21. An example method for assisting photovoltaic panel array current distribution wiring system installation using a three-dimensional (3D) illustration of the photovoltaic panel array current distribution wiring system, comprises obtaining the 3D illustration of the photovoltaic panel array current distribution wiring system determined based on photovoltaic panel array current distribution wiring system installation parameters, illustrating the 3D illustration of the photovoltaic panel array current distribution wiring system to a plurality of virtual observers individually based on a field of view (FOV) of each virtual observer of the plurality of virtual observers, receiving inputs corresponding to photovoltaic panel array current distribution wiring system installation operations from the plurality of virtual observers, and updating the 3D illustration of the photovoltaic panel array current distribution wiring system based on the inputs from the plurality of virtual observers.

Clause 22. The method of clause 21, wherein the photovoltaic panel array current distribution wiring system installation operations comprise: measuring a length of cable used in the photovoltaic panel array current distribution wiring system.

Clause 23. The method of clause 21 or 22, wherein illustrating the 3D illustration of the photovoltaic panel array current distribution wiring system to a plurality of virtual observers individually further comprises: tracking eye movements, facial expression, or both, of the virtual observer.

Clause 24. The method of any clause of 21-23, wherein inputs corresponding to photovoltaic panel array current distribution wiring system installation operations comprises: marking bracket component models illustrated in the 3D illustration of the photovoltaic panel array current distribution wiring system.

Clause 25. The method of any clause of 21-24, wherein updating the 3D illustration of the photovoltaic panel array current distribution wiring system based on the inputs from the plurality of virtual observers further comprises marking typical bracket component models within the 3D illustration of the photovoltaic panel array current distribution wiring system according to the inputs.

Clause 26. An example method for three-dimensional (3D) illustration of a photovoltaic panel array current distribution wiring system, comprises obtaining the 3D illustration of the photovoltaic panel array current distribution wiring system determined based on photovoltaic panel array current distribution wiring system installation parameters, illustrating the 3D illustration of the photovoltaic panel array current distribution wiring system to a virtual observer based on a field of view (FOV) of the virtual observer, receiving inputs corresponding to inquiry of information of equipment or processes of the photovoltaic panel array current distribution wiring system, and providing feedback responsive to the user input.

Clause 27. The method of clause 26, wherein the inputs further comprise: requesting a cross-sectional detail of a component of the photovoltaic panel array current distribution wiring system.

Clause 28. The method of clause 26 or 27, wherein the inputs are received through tracking hand movements of the virtual observer.

Clause 29. An example computer-readable medium storing instructions for generating a three-dimensional (3D) illustration of a photovoltaic panel array current distribution wiring system for photovoltaic panel array current distribution wiring system installation, the instructions comprising code for obtaining initial photovoltaic panel array current distribution wiring system installation parameters, determining the 3D illustration of the photovoltaic panel array current distribution wiring system based on the initial photovoltaic panel array current distribution wiring system installation parameters and information of a site environment of the photovoltaic panel array current distribution wiring system, and determining actual photovoltaic panel array current distribution wiring system installation parameters using the 3D illustration of the photovoltaic panel array current distribution wiring system.

Clause 30. The computer-readable medium of clause 29, wherein the initial photovoltaic panel array current distribution wiring system installation parameters comprise data from a bracket diagram, a wiring diagram, or both, determined for the photovoltaic panel array current distribution wiring system installation.

Clause 31. The computer-readable medium of clause 29 or 30, wherein the data from the bracket diagram comprises: specifications for photovoltaic modules; dimensions of bracket motors; types and models of injection-molded parts; dimensions of clamps; types of hooks; pile position data; or any combination thereof.

Clause 32. The computer-readable medium of any clause of 29-31, wherein determining the 3D model illustration of the photovoltaic panel array current distribution wiring system further comprises: modeling components of the photovoltaic panel array current distribution wiring system, wherein the components comprise photovoltaic modules; positioning at least one of the modeled components; and connecting the photovoltaic modules.

Clause 33. The computer-readable medium of any clause of 29-32, wherein connecting the photovoltaic modules comprises series connections; jump connections; polarity connections; or any combination thereof.

Clause 34. The computer-readable medium of any clause of 29-33, wherein determining the 3D model illustration of the photovoltaic panel array current distribution wiring system further comprises: routing cables connecting at least some of the modeled components; and binding the cables according to on-site requirements.

Clause 35. The computer-readable medium of any clause of 29-34, wherein determining the 3D model illustration of the photovoltaic panel array current distribution wiring system further comprises: performing material mapping based on extracting textures through comparisons with images of actual site; performing model photography by simulating from various camera angles; and performing post-rendering adjustments.

Clause 36. The computer-readable medium of any clause of 29-35, wherein determining the actual photovoltaic panel array current distribution wiring system installation parameters further comprises: determining an actual total cable length for the photovoltaic panel array current distribution wiring system installation.

Clause 37. The computer-readable medium of any clause of 29-36, wherein the 3D illustration of the photovoltaic panel array current distribution wiring system comprises a 3D exclusive rendered video, a 3D exclusive page diagram, or both, wherein the 3D illustration of the photovoltaic panel array current distribution wiring system indicates the actual photovoltaic panel array current distribution wiring system installation parameters.

Clause 38. An example computer-readable medium storing instructions for assisting photovoltaic panel array current distribution wiring system installation using a three-dimensional (3D) illustration of the photovoltaic panel array current distribution wiring system, the instructions comprising code for obtaining the 3D illustration of the photovoltaic panel array current distribution wiring system determined based on photovoltaic panel array current distribution wiring system installation parameters, illustrating the 3D illustration of the photovoltaic panel array current distribution wiring system to a virtual observer based on a field of view (FOV) of the virtual observer, receiving inputs corresponding to photovoltaic panel array current distribution wiring system installation operations from the virtual observer, and providing feedback responsive to the inputs.

Clause 39. The computer-readable medium of clause 38, wherein the photovoltaic panel array current distribution wiring system installation operations comprise installing a photovoltaic module in corresponding positions on brackets.

Clause 40. The computer-readable medium of clause 38 or 39, wherein the appropriate tool comprises a wire spool, a wire box, or both.

Clause 41. The computer-readable medium of any clause of 38-40, wherein the photovoltaic panel array current distribution wiring system installation operations comprise selecting appropriate tool for performing the photovoltaic panel array current distribution wiring system installation operations.

Clause 42. The computer-readable medium of any clause of 38-41, wherein providing feedback responsive to the input further comprises: in response to the inputs being correct, providing a first response; and in response to the inputs being incorrect, providing a second response, different from the first response, wherein whether the inputs are correct is determined based on predetermined rules.

Clause 43. The computer-readable medium of any clause of 38-42, wherein the first and second responses comprises sound effects, text prompt, vibration, or any combination thereof.

Clause 44. An example computer-readable medium storing instructions for three-dimensional (3D) illustration of a real-world photovoltaic cable manufacturing facility, the instructions comprising code for obtaining the 3D illustration of the real-world photovoltaic cable manufacturing facility, illustrating the 3D illustration to a virtual observer based on a field of view (FOV) of the virtual observer, wherein the 3D illustration illustrates equipment and processes for manufacturing photovoltaic cables, receiving the virtual observer inputs corresponding to inquiry of information of equipment or processes of the real-world photovoltaic cable manufacturing facility, and providing the inquired information to the virtual observer.

Clause 45. The computer-readable medium of clause 46, wherein the information of components of the real-world photovoltaic cable manufacturing facility comprises manufacturing processes performed on corresponding components.

Clause 46. The computer-readable medium of clause 46 or 47, wherein obtaining the 3D illustration of the real-world photovoltaic cable manufacturing facility comprises: capturing media assets of the real-world photovoltaic cable manufacturing facility using a 360° panoramic camera.

Clause 47. The computer-readable medium of any clause of 46-48, wherein the 3D illustration is illustrated using a virtual reality device.

Clause 48. The computer-readable medium of any clause of 46-49, wherein the 3D illustration indicates characteristics of the real-world photovoltaic cable manufacturing facility that comprises: a facility production scale; a facility layout; a facility on-site environment; management information; or any combination thereof.

Clause 49. An example computer-readable medium storing instructions for assisting photovoltaic panel array current distribution wiring system installation using a three-dimensional (3D) illustration of the photovoltaic panel array current distribution wiring system, the instructions comprising code for obtaining the 3D illustration of the photovoltaic panel array current distribution wiring system determined based on photovoltaic panel array current distribution wiring system installation parameters, illustrating the 3D illustration of the photovoltaic panel array current distribution wiring system to a plurality of virtual observers individually based on a field of view (FOV) of each virtual observer of the plurality of virtual observers, receiving inputs corresponding to photovoltaic panel array current distribution wiring system installation operations from the plurality of virtual observers, and updating the 3D illustration of the photovoltaic panel array current distribution wiring system based on the inputs from the plurality of virtual observers.

Clause 50. The computer-readable medium of clause 49, wherein the photovoltaic panel array current distribution wiring system installation operations comprise: measuring a length of cable used in the photovoltaic panel array current distribution wiring system.

Clause 51. The computer-readable medium of clause 49 or 50, wherein illustrating the 3D illustration of the photovoltaic panel array current distribution wiring system to a plurality of virtual observers individually further comprises: tracking eye movements, facial expression, or both, of the virtual observer.

Clause 52. The computer-readable medium of any clause of 49-51, wherein inputs corresponding to photovoltaic panel array current distribution wiring system installation operations comprises: marking bracket component models illustrated in the 3D illustration of the photovoltaic panel array current distribution wiring system.

Clause 53. The computer-readable medium of any clause of 49-52, wherein updating the 3D illustration of the photovoltaic panel array current distribution wiring system based on the inputs from the plurality of virtual observers further comprises marking typical bracket component models within the 3D illustration of the photovoltaic panel array current distribution wiring system according to the inputs.

Clause 54. An example computer-readable medium storing instructions for three-dimensional (3D) illustration of a photovoltaic panel array current distribution wiring system, the instructions comprising code for obtaining the 3D illustration of the photovoltaic panel array current distribution wiring system determined based on photovoltaic panel array current distribution wiring system installation parameters, illustrating the 3D illustration of the photovoltaic panel array current distribution wiring system to a virtual observer based on a field of view (FOV) of the virtual observer, receiving inputs corresponding to an inquiry of information of equipment or processes of the photovoltaic panel array current distribution wiring system, and providing feedback responsive to the user input.

Clause 55. The computer-readable medium of clause 54, wherein the inputs further comprise: requesting a cross-sectional detail of a component of the photovoltaic panel array current distribution wiring system.

Clause 56. The computer-readable medium of clause 54 or 55, wherein the inputs are received through tracking hand movements of the virtual observer.

What is claimed is:

1. A method for generating a three-dimensional (3D) illustration of a photovoltaic panel array current distribution wiring system for photovoltaic panel array current distribution wiring system installation, comprising:
obtaining initial photovoltaic panel array current distribution wiring system installation parameters;
determining the 3D illustration of the photovoltaic panel array current distribution wiring system based on the initial photovoltaic panel array current distribution wiring system installation parameters and information of a site environment of the photovoltaic panel array current distribution wiring system; and
determining actual photovoltaic panel array current distribution wiring system installation parameters using the 3D illustration of the photovoltaic panel array current distribution wiring system.

2. The method of claim 1, wherein the initial photovoltaic panel array current distribution wiring system installation parameters comprise data from a bracket diagram, a wiring diagram, or both, determined for the photovoltaic panel array current distribution wiring system installation.

3. The method of claim 2, wherein the data from the bracket diagram comprises:
specifications for photovoltaic modules;
dimensions of bracket motors;
types and models of injection-molded parts;
dimensions of clamps;
types of hooks;
pile position data; or
any combination thereof.

4. The method of claim 3, wherein determining the 3D illustration of the photovoltaic panel array current distribution wiring system further comprises:
modeling components of the photovoltaic panel array current distribution wiring system, wherein the components comprise photovoltaic modules;
positioning at least one of the modeled components; and
connecting the photovoltaic modules.

5. The method of claim 4, wherein connecting the photovoltaic modules comprises series connections;
jump connections;
polarity connections; or
any combination thereof.

6. The method of claim 4, wherein determining the 3D model illustration of the photovoltaic panel array current distribution wiring system further comprises:
routing cables connecting at least some of the modeled components; and
binding the cables according to on-site requirements.

7. The method of claim 4, wherein determining the 3D model illustration of the photovoltaic panel array current distribution wiring system further comprises:
performing material mapping based on extracting textures through comparisons with images of actual site;
performing model photography by simulating from various camera angles; and
performing post-rendering adjustments.

8. The method of claim 1, wherein determining the actual photovoltaic panel array current distribution wiring system installation parameters further comprises:
determining an actual total cable length for the photovoltaic panel array current distribution wiring system installation.

9. The method of claim 1, wherein the 3D illustration of the photovoltaic panel array current distribution wiring system comprises a 3D exclusive rendered video, a 3D exclusive page diagram, or both, wherein the 3D illustration of the photovoltaic panel array current distribution wiring system indicates the actual photovoltaic panel array current distribution wiring system installation parameters.

10. A method for assisting photovoltaic panel array current distribution wiring system installation using a three-dimensional (3D) illustration of the photovoltaic panel array current distribution wiring system, comprising:
obtaining the 3D illustration of the photovoltaic panel array current distribution wiring system determined based on photovoltaic panel array current distribution wiring system installation parameters;
illustrating the 3D illustration of the photovoltaic panel array current distribution wiring system to a virtual observer based on a field of view (FOV) of the virtual observer;
receiving inputs corresponding to photovoltaic panel array current distribution wiring system installation operations from the virtual observer; and
providing feedback responsive to the inputs.

11. The method of claim 10, wherein the photovoltaic panel array current distribution wiring system installation operations comprise installing a photovoltaic module in corresponding positions on brackets.

12. The method of claim 11, wherein the appropriate tool comprises a wire spool, a wire box, or both.

13. The method of claim 10, wherein the photovoltaic panel array current distribution wiring system installation operations comprise selecting appropriate tool for performing the photovoltaic panel array current distribution wiring system installation operations.

14. The method of claim 10, wherein providing feedback responsive to the input further comprises:
in response to the inputs being correct, providing a first response; and
in response to the inputs being incorrect, providing a second response, different from the first response, wherein whether the inputs are correct is determined based on predetermined rules.

15. The method of claim 14, wherein the first and second responses comprises sound effects, text prompt, vibration, or any combination thereof.

16. A method for three-dimensional (3D) illustration of a real-world photovoltaic cable manufacturing facility, comprising:
obtaining the 3D illustration of the real-world photovoltaic cable manufacturing facility;
illustrating the 3D illustration to a virtual observer based on a field of view (FOV) of the virtual observer, wherein the 3D illustration illustrates equipment and processes for manufacturing photovoltaic cables;
receiving the virtual observer inputs corresponding to an inquiry of information of equipment or processes of the real-world photovoltaic cable manufacturing facility; and
providing the inquired information to the virtual observer.

17. The method of claim 16, wherein the information of components of the real-world photovoltaic cable manufacturing facility comprises manufacturing processes performed on corresponding components.

18. The method of claim 16, wherein obtaining the 3D illustration of the real-world photovoltaic cable manufacturing facility comprises:
capturing media assets of the real-world photovoltaic cable manufacturing facility using a 360° panoramic camera.

19. The method of claim 16, wherein the 3D illustration is illustrated using a virtual reality device.

20. The method of claim 16, wherein the 3D illustration indicates characteristics of the real-world photovoltaic cable manufacturing facility that comprises:
a facility production scale;
a facility layout;
a facility on-site environment;
management information; or
any combination thereof.

21. A method for assisting photovoltaic panel array current distribution wiring system installation using a three-dimensional (3D) illustration of the photovoltaic panel array current distribution wiring system, comprising:
obtaining the 3D illustration of the photovoltaic panel array current distribution wiring system determined based on photovoltaic panel array current distribution wiring system installation parameters;
illustrating the 3D illustration of the photovoltaic panel array current distribution wiring system to a plurality of virtual observers individually based on a field of view (FOV) of each virtual observer of the plurality of virtual observers;
receiving inputs corresponding to photovoltaic panel array current distribution wiring system installation operations from the plurality of virtual observers; and
updating the 3D illustration of the photovoltaic panel array current distribution wiring system based on the inputs from the plurality of virtual observers.

22. The method of claim 21, wherein the photovoltaic panel array current distribution wiring system installation operations comprise:
measuring a length of cable used in the photovoltaic panel array current distribution wiring system.

23. The method of claim 21, wherein illustrating the 3D illustration of the photovoltaic panel array current distribution wiring system to a plurality of virtual observers individually further comprises:
tracking eye movements, facial expression, or both, of the virtual observer.

24. The method of claim 21, wherein inputs corresponding to photovoltaic panel array current distribution wiring system installation operations comprises:
marking bracket component models illustrated in the 3D illustration of the photovoltaic panel array current distribution wiring system.

25. The method of claim 21, wherein updating the 3D illustration of the photovoltaic panel array current distribution wiring system based on the inputs from the plurality of virtual observers further comprises marking typical bracket component models within the 3D illustration of the photovoltaic panel array current distribution wiring system according to the inputs.

26. A method for three-dimensional (3D) illustration of a photovoltaic panel array current distribution wiring system, comprising:
obtaining the 3D illustration of the photovoltaic panel array current distribution wiring system determined based on photovoltaic panel array current distribution wiring system installation parameters;
illustrating the 3D illustration of the photovoltaic panel array current distribution wiring system to a virtual observer based on a field of view (FOV) of the virtual observer;
receiving inputs corresponding to an inquiry of information of equipment or processes of the photovoltaic panel array current distribution wiring system; and
providing feedback responsive to the inputs.

27. The method of claim 26, wherein the inputs further comprise:
requesting a cross-sectional detail of a component of the photovoltaic panel array current distribution wiring system.

28. The method of claim 27, wherein the inputs are received through tracking hand movements of the virtual observer.

29. A non-transitory computer-readable medium storing instructions for generating a three-dimensional (3D) illustration of a photovoltaic panel array current distribution wiring system for photovoltaic panel array current distribution wiring system installation, the instructions comprising code for:
obtaining initial photovoltaic panel array current distribution wiring system installation parameters;
determining the 3D illustration of the photovoltaic panel array current distribution wiring system based on the initial photovoltaic panel array current distribution wiring system installation parameters and information of a site environment of the photovoltaic panel array current distribution wiring system; and
determining actual photovoltaic panel array current distribution wiring system installation parameters using the 3D illustration of the photovoltaic panel array current distribution wiring system.

30. The computer-readable medium of claim 29, wherein the initial photovoltaic panel array current distribution wiring system installation parameters comprise data from a bracket diagram, a wiring diagram, or both, determined for the photovoltaic panel array current distribution wiring system installation.

31. The computer-readable medium of claim 29, wherein the data from the bracket diagram comprises:
specifications for photovoltaic modules;
dimensions of bracket motors;
types and models of injection-molded parts;
dimensions of clamps;
types of hooks;
pile position data; or
any combination thereof.

32. The computer-readable medium of claim 31, wherein determining the 3D illustration of the photovoltaic panel array current distribution wiring system further comprises:
modeling components of the photovoltaic panel array current distribution wiring system, wherein the components comprise photovoltaic modules;
positioning at least one of the modeled components; and
connecting the photovoltaic modules.

33. The computer-readable medium of claim 32, wherein connecting the photovoltaic modules comprises
series connections;
jump connections;
polarity connections; or
any combination thereof.

34. The computer-readable medium of claim 32, wherein determining the 3D model illustration of the photovoltaic panel array current distribution wiring system further comprises:
routing cables connecting at least some of the modeled components; and
binding the cables according to on-site requirements.

35. The computer-readable medium of claim 32, wherein determining the 3D model illustration of the photovoltaic panel array current distribution wiring system further comprises:
performing material mapping based on extracting textures through comparisons with images of actual site;
performing model photography by simulating from various camera angles; and
performing post-rendering adjustments.

36. The computer-readable medium of claim 29, wherein determining the actual photovoltaic panel array current distribution wiring system installation parameters further comprises:
determining an actual total cable length for the photovoltaic panel array current distribution wiring system installation.

37. The computer-readable medium of claim 29, wherein the 3D illustration of the photovoltaic panel array current distribution wiring system comprises a 3D exclusive rendered video, a 3D exclusive page diagram, or both, wherein the 3D illustration of the photovoltaic panel array current distribution wiring system indicates the actual photovoltaic panel array current distribution wiring system installation parameters.

38. A non-transitory computer-readable medium storing instructions for assisting photovoltaic panel array current distribution wiring system installation using a three-dimensional (3D) illustration of the photovoltaic panel array current distribution wiring system, the instructions comprising code for:
obtaining the 3D illustration of the photovoltaic panel array current distribution wiring system determined based on photovoltaic panel array current distribution wiring system installation parameters;
illustrating the 3D illustration of the photovoltaic panel array current distribution wiring system to a virtual observer based on a field of view (FOV) of the virtual observer;
receiving inputs corresponding to photovoltaic panel array current distribution wiring system installation operations from the virtual observer; and
providing feedback responsive to the inputs.

39. The computer-readable medium of claim 38, wherein the photovoltaic panel array current distribution wiring system installation operations comprise installing a photovoltaic module in corresponding positions on brackets.

40. The computer-readable medium of claim 39, wherein the appropriate tool comprises a wire spool, a wire box, or both.

41. The computer-readable medium of claim 38, wherein the photovoltaic panel array current distribution wiring system installation operations comprise selecting appropriate tool for performing the photovoltaic panel array current distribution wiring system installation operations.

42. The computer-readable medium of claim 38, wherein providing feedback responsive to the input further comprises:
in response to the inputs being correct, providing a first response; and
in response to the inputs being incorrect, providing a second response, different from the first response, wherein whether the inputs are correct is determined based on predetermined rules.

43. The computer-readable medium of claim 42, wherein the first and second responses comprises sound effects, text prompt, vibration, or any combination thereof.

44. A non-transitory computer-readable medium storing instructions for three-dimensional (3D) illustration of a real-world photovoltaic cable manufacturing facility, the instructions comprising code for:
obtaining the 3D illustration of the real-world photovoltaic cable manufacturing facility;
illustrating the 3D illustration to a virtual observer based on a field of view (FOV) of the virtual observer, wherein the 3D illustration illustrates equipment and processes for manufacturing photovoltaic cables;
receiving the virtual observer inputs corresponding to an inquiry of information of equipment or processes of the real-world photovoltaic cable manufacturing facility; and
providing the inquired information to the virtual observer.

45. The computer-readable medium of claim 44, wherein the information of components of the real-world photovoltaic cable manufacturing facility comprises manufacturing processes performed on corresponding components.

46. The computer-readable medium of claim 44, wherein obtaining the 3D illustration of the real-world photovoltaic cable manufacturing facility comprises:
capturing media assets of the real-world photovoltaic cable manufacturing facility using a 360° panoramic camera.

47. The computer-readable medium of claim 44, wherein the 3D illustration is illustrated using a virtual reality device.

48. The computer-readable medium of claim 44, wherein the 3D illustration indicates characteristics of the real-world photovoltaic cable manufacturing facility that comprises:
a facility production scale;
a facility layout;
a facility on-site environment;
management information; or
any combination thereof.

49. A non-transitory computer-readable medium storing instructions for assisting photovoltaic panel array current distribution wiring system installation using a three-dimensional (3D) illustration of the photovoltaic panel array current distribution wiring system, the instructions comprising code for:
obtaining the 3D illustration of the photovoltaic panel array current distribution wiring system determined based on photovoltaic panel array current distribution wiring system installation parameters;
illustrating the 3D illustration of the photovoltaic panel array current distribution wiring system to a plurality of virtual observers individually based on a field of view (FOV) of each virtual observer of the plurality of virtual observers;
receiving inputs corresponding to photovoltaic panel array current distribution wiring system installation operations from the plurality of virtual observers; and
updating the 3D illustration of the photovoltaic panel array current distribution wiring system based on the inputs from the plurality of virtual observers.

50. The computer-readable medium of claim 49, wherein the photovoltaic panel array current distribution wiring system installation operations comprise:
measuring a length of cable used in the photovoltaic panel array current distribution wiring system.

51. The computer-readable medium of claim 49, wherein illustrating the 3D illustration of the photovoltaic panel array current distribution wiring system to a plurality of virtual observers individually further comprises:
tracking eye movements, facial expression, or both, of the virtual observer.

52. The computer-readable medium of claim 49, wherein inputs corresponding to photovoltaic panel array current distribution wiring system installation operations comprises:
marking bracket component models illustrated in the 3D illustration of the photovoltaic panel array current distribution wiring system.

53. The computer-readable medium of claim 49, wherein updating the 3D illustration of the photovoltaic panel array current distribution wiring system based on the inputs from the plurality of virtual observers further comprises marking typical bracket component models within the 3D illustration of the photovoltaic panel array current distribution wiring system according to the inputs.

54. A non-transitory computer-readable medium storing instructions for three-dimensional (3D) illustration of a photovoltaic panel array current distribution wiring system, the instructions comprising code for:
obtaining the 3D illustration of the photovoltaic panel array current distribution wiring system determined based on photovoltaic panel array current distribution wiring system installation parameters;
illustrating the 3D illustration of the photovoltaic panel array current distribution wiring system to a virtual observer based on a field of view (FOV) of the virtual observer;
receiving inputs corresponding to an inquiry of information of equipment or processes of the photovoltaic panel array current distribution wiring system; and
providing feedback responsive to the inputs.

55. The computer-readable medium of claim 54, wherein the inputs further comprise:
requesting a cross-sectional detail of a component of the photovoltaic panel array current distribution wiring system.

56. The computer-readable medium of claim 55, wherein the inputs are received through tracking hand movements of the virtual observer.
